(19) United States
(12) Patent Application Publication
(10) Pub. No.: US 2010/0037776 A1
(43) Pub. Date: Feb. 18, 2010

(54) Devices for removing particles from a gas comprising an electrostatic precipitator

(76) Inventor: Sik Leung Chan, Tsuen Wan (HK)

Correspondence Address: Daniel P. Burke, Esq.;Daniel P. Burke & Associates, PLLC, 240 Townsend Square, Oyster Bay, NY, 11771, US

(21) Appl. No.: 12/228,578

(22) Filed: Aug. 14, 2008

(51) Int. Cl. B03C 3/12

(52) U.S. Cl. 96/80

(57) ABSTRACT

Air or gas cleaners enhance the uniformity of the current density between an emitter and one or more receptor electrodes by positioning one or more insulators or effective resistors between the emitter and the receptor electrode. Insulators and/or effective resistors are used to shield select portions, e.g. the edges of plate-type receptor electrodes, from ionization current flowing between an emitter and unshielded portions. This allows more compact structures without ionization current concentrations at the shielded regions, and results in lower ozone generation for a given particle collection efficiency.

The present invention relates to devices for removing particles from gases comprising an electrostatic precipitator, and is particularly suited for air cleaners.

### BACKGROUND

Various types of electrostatic air cleaners are already known in the art. The arrangement of some basic elements of two types of electrostatic air cleaners known in the prior art are shown in FIGS. 1 and 2. The device shown in FIG. 1 uses a wire as the emitter and plates as integrated receptor/collector structure. The device shown in FIGS. 2A and 2B uses a pin point type emitter and a tube as the integrated receptor/collector structure. All of the elements illustrated in FIGS. 1 and 2 are made of electrical conductors. As a high enough electrical potential difference is applied between the emitters and the receptor/collector structures, the air gap between them becomes partially conductive and an electrical current flows across the gap. This region is known as a corona and the current created is called the ionization current. As air moves through the corona region, particles, such as the dust, in the air get charged. The charged particles are attracted by the collectors and deposit on them. To enhance the rate of deposition (sometimes referred to as the rate of precipitation), it is common to also provide a driver electrode with a potential difference between the driver electrode and the collector electrode. The electrical potential can be provided to the driver electrode in several ways known in the art, including actively or passively. The use of driver electrodes provides additional electric fields which accelerate deposition of the charged dust particles on the collector.

The air to be cleaned is caused to flow through the corona region and between the driver and collector electrodes. It is common to move the air by fans and/or by electrostatic propulsion. As the air molecules around the emitter are charged, they are moved toward the receptor electrode(s) by the electrical field between them. This air movement through the receptors and collectors is called electrostatic propulsion. If the receptors are placed nearer to an air outlet than the emitters, air will flow toward the outlet of the unit if the flow resistance downstream of the corona is small.

The main advantage of electrostatic air cleaners is that the collector electrodes act as filters by capturing particles, and are cleanable and reusable.

### SUMMARY OF THE INVENTION

Embodiments of the present invention enhance the uniformity of the current density between an emitter and one or more receptor electrodes having flat surfaces or low curvature structures, e.g. flat plates, by positioning one or more insulators in the shortest path between the emitter and the closest structure of the receptor electrode.

As used herein, the terms “insulator” and “insulation” are used to indicate a material of such low conductivity that the flow of ionization current through it is negligible, i.e. it has a sufficient volume resistivity and thickness such that the insulator prevents at least 99% of the ionization current flowing to that electrode from flowing through the insulator under normal operating conditions. As explained in greater detail below, the insulator is placed either on or proximate the receptor electrode. Due to the shielding of the receptor electrodes as described herein, particle deposition on the unshielded regions has been found to be more than double that on the shielded regions. Preferred materials have a volume resistivity of at least 1×10¹³ ohm-cm, most preferably at least 1×10¹⁵ ohm-cm. According to one embodiment, all measurable amounts of the ionization current are prevented from flowing to the shielded portion of the receptor electrode(s) under normal operating conditions.

Other embodiments shield a portion of a receptor electrode or a receptor/collector electrode with an effective resistor. The term “effective resistor” as used herein, is defined below. Utilizing embodiments of the present invention, ozone generation can be minimized by keeping the ionization current density in the corona as uniform as possible and by keeping the ionization current low. When a corona is created between an emitter having a small radius and a conductive structure with a low curvature, such as a flat surface, i.e. not an edge, the current density will tend to be more uniform than in a corona created between the same emitter and a portion of a receptor electrode comprising a change in curvature, e.g. a bend, or a change in continuity in a surface, e.g. an edge. As used herein, the term “receptor electrode” refers to an electrode or the portion(s) of an electrode which cooperates with an emitter electrode to establish a corona.

The electric field intensity, which has an inverse relationship with the radii of the emitter or receptor electrode, affects the current flow of a corona. To create a high electric field intensity for the ionization of the surrounding air sufficient to generate a corona, a conductor with a small radius such as a thin wire or pinpoint is usually used. In the prior art shown in FIGS. 1 and 2, as the ionized air is attracted toward a receptor electrode (or the receptor electrode portion of a receptor/collector electrode), more of the ionization current moves toward portions of the receptor electrode with smaller radii such as an edge or irregularity on the receptor electrode surfaces, than to portions of lower curvature, such as flat surfaces. Thus the ionization current will be denser at the edges than at flat surfaces on the receptor electrode. In other words, the current density will not be uniform at these different portions of the receptor electrode. As noted above, ozone generation is minimized by keeping the ionization current more uniform.

Since the edges of a receptor electrode are usually the largest irregularity with relatively small and sometimes non-uniform radii, preventing ionization current flow to these edges of a receptor electrode by shielding them with insulators will reduce the tendency for the current to concentrate in these areas and enhance the uniformity of the current density.

Placing an insulator or an effective resistor between the emitter and at least one portion of its corresponding receptor electrode also enables a higher electric potential difference to be maintained between the emitter and receptor electrode for a specific ionization current without causing arcing. The resulting higher electric field intensity will charge the dust particles in the airflow passing through the corona more effectively, providing better collection efficiencies without affecting ozone generation. Hence the charging effect can be maintained at a relatively higher rate for a given ionization current in the corona, while maintaining a more uniform current density than would occur without the insulation or the effective resistor.

According to one embodiment, insulators are used to insulate a portion of a plate-type receptor electrode comprising a change in curvature, e.g. a bend, or a change in continuity in a surface, e.g. an edge. This design allows more compact structures without current concentrations at different sections of the receptor electrode, e.g. the edges, and results in lower ozone generation at a given specific particle capture rate as explained further below.

According to other embodiments, insulators are used to insulate a portion of a receptor electrode which does not comprise a change in curvature or a change in continuity in the portion shielded by an insulator. As used herein, the term “change of curvature” is used to indicate a surface with a change of slope, e.g. from flat to curved, from curved to flat, and/or from curved with a first radius of curvature to curved with a different radius of curvature. The term “change in continuity” is used to indicate some abrupt change in the surface of the electrode, such as an edge or a hole in the electrode.

According to another embodiment of the present invention, an effective resistor shields a portion of a receptor electrode comprising a change in curvature or a change in continuity in a surface. According to a still further embodiment, an effective resistor shields a portion of a receptor electrode which does not comprise a change in curvature or a change in continuity of a surface.

Other embodiments comprise an air cleaner comprising an electrostatic precipitator comprising at least one emitter and at least one receptor electrode, the emitter and the receptor electrode are maintained at different potentials wherein the difference is sufficient to create an ionization current, the portion of the receptor electrode closest to the emitter does not comprise a change of curvature or change in continuity, e.g. a bend or an edge, and is shielded by an insulator

A still further embodiment of the present invention comprises a portable, self-contained air cleaner comprising an electrostatic precipitator comprising at least one wire emitter; at least one readily conductive, plate-type receptor electrode spaced from said emitter; said receptor electrode comprising a shielded region comprising at least a first surface and at least one of a change of curvature or a change in continuity of said surface; said receptor electrode also comprising a non-shielded region comprising at least one surface; insulation positioned between said emitter and said shielded region; means for maintaining said emitter and said receptor electrode at different voltage potentials sufficient to create an ionization current between said emitter and at least a portion of said non-shielded region of said receptor electrode. One such air cleaner weighs less than 50 pounds. Another such portable, self-contained air cleaner comprises at least five receptor electrodes, at least five collector electrodes formed either independently or integrally with the receptor electrodes, a plurality of driver electrodes, at least one and preferably a plurality of fans to induce an airflow past the receptor electrodes, and a protective housing, and weighs less than 30 pounds.

While the advantages of the present invention can be applied to electrostatic precipitators used to remove particles from various types of gases, including industrial gases, preferred embodiments of the present invention are air cleaners which are used to remove dust and other particles from breathable air.

As used herein, the term “particles” is not used to include subatomic particles, but refers to particles having size similar to the size of normal dust particle in normal household air. For example, the Example described below utilized particles having a size of greater than 0.3 micrometers as reference particles.

While it is preferred that the emitter and the receptor electrode have opposite charges, it is also within the scope of the present invention to have the emitter and receptor electrodes at the same charge, i.e. both positive or both negative, provided that the potential difference is sufficient to create an ionization current.

### BRIEF DESCRIPTION OF THE DRAWINGS

The following drawings illustrate several embodiments of the present invention.

FIG. 1 is a cross-sectional view of a prior art electrostatic precipitator air cleaner of the wire-plate configuration.

FIGS. 2A and 2B are cross-sectional views of a prior art electrostatic precipitator air cleaner comprising a pin-type emitter with a tubular receptor/collector electrode and a wire driver electrode. FIG. 2B is a view taken along lines B-B of FIG. 2A, while FIG. 2A is a cross-sectional view taken along lines A-A of FIG. 2B.

FIG. 3 is a cross-sectional view of one embodiment of the present invention wherein the upstream edges of plate-type receptor electrodes are insulated.

FIGS. 4A and 4B illustrate an alternative embodiment of the present invention utilizing a pin-type emitter with a tubular receptor/collector electrode.

FIG. 5 illustrates another embodiment of the present invention utilizing separate receptor electrodes and collector electrodes with upstream and downstream edges of the plate-type receptor electrodes insulated.

FIGS. 6 and 6A illustrate an alternative embodiment of the present invention wherein insulators are positioned in spaced relation to the edges of receptor/collector electrodes.

FIG. 7 illustrates an embodiment of the present invention comprising a wire-plate electrostatic precipitator with a driver electrode wherein the edges of the driver electrode plate are insulated.

FIG. 8 illustrates a still further embodiment of the present invention comprising a wire-plate electrostatic precipitator with a driver electrode plate shielded with an insulator.

FIG. 9 illustrates an alternative embodiment of the present invention wherein receptor electrode plates comprise insulated surfaces and a wire emitter is positioned between the plates, midway along the longitudinal axis of the insulated portions.

FIG. 10 illustrates an alternative embodiment similar to the embodiment of FIG. 9, but wherein the wire emitter is positioned further downstream than the midpoint of the insulated portions.

FIG. 11 shows the prior art electrostatic precipitator of FIG. 1 illustrating the present inventor's understanding of the predominant flow of ionization current in this prior art electrostatic precipitator.

FIG. 12 illustrates the present inventor's understanding of the ionization current flow of the embodiment of the present invention shown in FIG. 3.

FIG. 13 illustrates an embodiment of the present invention comprising a plurality of wire-type emitter electrodes, receptor/collector electrodes and driver electrodes.

FIGS. 14A and 14B are a cross-sectional and side view, respectively, of a still further embodiment of the present invention wherein insulation on the edges of receptor/collector electrodes extends downstream beyond the upstream edge of a driver electrode.

FIG. 15 illustrates an alternative embodiment of the present invention wherein a single emitter electrode is utilized with more than two collector electrodes.

FIG. 16 illustrates an embodiment of the present invention wherein a single emitter is utilized with more than two collector electrodes having shielded upstream edges and driver electrodes with upstream and downstream edges shielded.

FIG. 17 illustrates an embodiment similar to the embodiment of FIG. 16, but wherein the entire surfaces of the driver electrodes are shielded.

FIG. 18 illustrates and embodiment wherein a single emitter is positioned to create an ionization current with four receptor/collector electrodes.

FIGS. 19A and 19B are a cross-sectional and side view, respectively, of a further embodiment of the present invention using a pinpoint emitter comprising many pinpoints and a receptor/collector electrode having all edges shielded.

FIG. 20 illustrates an alternative embodiment of the present invention comprising a wire-type emitter, block-type receptor/collector electrodes and a driver electrode.

FIG. 21 illustrates an alternative embodiment wherein the receptor/collector electrodes are in the form of angled plates.

FIG. 22 illustrates an alternative embodiment of the present invention comprising receptor/collector electrodes having rounded upstream edges.

FIG. 23 illustrates an alternative embodiment of the present invention comprising two, wire-type emitters positioned between two shielded receptor/collector electrodes, and a plurality of additional collector electrodes and driver electrodes.

FIG. 24 illustrates an alternative embodiment of the present invention wherein upstream edges of plate-type receptor/collector electrodes are curved.

FIGS. 25 and 26 illustrate a prior art configuration and an arrangement of the present invention, respectively, utilized for a comparison test.

FIG. 27 illustrates an alternative embodiment comprising receptor electrodes and a separate, integrated receptor/collector electrode.

FIG. 28 illustrates a still further embodiment comprising receptor electrodes spaced from separate collector electrodes.

FIG. 29 illustrates a still further embodiment wherein a wire emitter is positioned proximate a portion of the ionization section of a receptor/collector electrode comprising a change in curvature.

FIG. 30 illustrates an alternative embodiment comprising a wire emitter and a receptor/collector electrode wherein a small portion of the collector section is insulated.

FIG. 31 illustrates a still further embodiment comprising a plurality of insulated receptor electrodes and receptor/collector electrodes.

FIG. 32 illustrates a still further embodiment comprising receptor/collector electrodes and additional electrodes.

FIGS. 33A and 33B are a cross-sectional and a side view, respectively, of an alternate embodiment comprising a wire emitter and a plurality of plate-type receptor/collector electrodes comprising insulation on longitudinal and a majority of the transverse edges.

FIG. 34 illustrates a still further embodiment wherein insulated electrodes are used to insulate intermediate portions of receptor/collector electrodes.

FIG. 35 illustrates a still further embodiment of the present invention wherein insulated electrodes are used to insulate edges of receptor/collector electrodes closest to a wire emitter.

FIG. 36 is a partial circuit diagram of one embodiment of the present invention.

FIG. 37 is a partial circuit diagram of an alternate embodiment of the present invention.

FIG. 38 is a partial circuit diagram of a still further embodiment of the present invention.

### DETAILED DESCRIPTION

The various embodiments of the present invention are devices for removing particles from gases, preferably electrostatic air cleaners, which utilize a corona discharge to charge particles in air and/or other gases. The various embodiments of the present invention are designed to minimize the production of undesirable ozone, or at least the production of measurable quantities of ozone utilizing standard measuring techniques such as that described in UL Ozone Standard 867. In preferred embodiments, ozone generation is minimized by minimizing the ionization current concentrations, i.e. providing a more uniform ionization current flow, between an emitter electrode and a receptor electrode by positioning one or more insulators between the emitter and a portion of the receptor electrode, preferably the portion closest to the emitter, while leaving at least one other surface of the receptor electrode unshielded by insulation. Other embodiments utilize effective resistors to significantly reduce the majority of ionization current flowing to portions of a receptor electrode shielded by an effective resistor. Embodiments of the present invention also allow higher electric potential differentials to be maintained between an emitter and receptor electrode, than if the receptor electrode was not insulated.

The electrodes of the present invention are formed of electrically conductive materials, and are most preferably readily conductive. As used herein, the term “readily conductive” is used to indicate a material which will not cause a potential drop equal to more than 5% of the potential difference between the emitter and receptor, as the ionization current is passing through the electrode during the operation of the air cleaner. For example, if the potential difference between the emitter and receptor is 10 kV, then the material used for a “readily conductive” electrode will not cause a potential drop greater than 0.5 kV as the ionization current is passing through that electrode during the operation of the air cleaner. The various elements of the present invention can be formed of materials known to those of ordinary skill in the art. The electrode can, for example, be formed of metals, metal alloys, carbon or carbon mixed with other materials, laminated materials, composite material or other materials which are durable in the intended environment. For ease of manufacture, suitable electrodes include electrodes formed of materials which are homogeneous throughout, and also have uniform conductivity properties throughout. For example, one common electrode material is aluminum plate having a thickness of about 0.5 mm. Such aluminum electrodes are generally formed homogeneously throughout for household air cleaners. Though oxides may form on the surfaces of such aluminum plate electrodes, for purposes of the present invention, those electrodes are considered to be homogeneous and to have uniform conductivity properties throughout, as they do at the time of their manufacture. Alternatively, non-homogeneous materials can be used for the electrodes. For example, electrodes comprising polyester plates sprayed with carbon paint, plastic plates electro-plated with layers of metals, or low cost steel sheets electro-plated for corrosion resistance may be used.

Examples of suitable insulation materials include, but are not limited to, polyester films, Teflon® films and ceramic coatings which are preferably applied continuously and evenly over the shielded region(s). Those skilled in the art will appreciate that the resistivity to the ionization current passing through the insulator, or an effective resistor, will depend upon the volume resistivity and the thickness of the material used. The insulator can be applied directly on the receptor electrode, i.e. in contact with the shielded portion of the receptor electrode, or can be supported to allow a gap, e.g. an air gap, between the insulator and at least a portion of the receptor electrode to be shielded. It will be appreciated by those skilled in the art that it can be very difficult to measure the current passing through an insulator of the type shown in the figures. To measure the insulative property of an insulator, the insulator can be placed between two flat conductors. A voltage of interest is applied to one conductor with a conventional microampere meter. Then the amount of current passing through that insulator, at the applied voltage, can be measured at the other conductor utilizing the meter.

The present invention is particularly suited for use with indoor air cleaners, e.g. portable air cleaners. Indoor air cleaners typically have dimensions of about 0.2 meter to about 2 meters in height, a width of about 60 mm to about 1 meter, a depth of about 150 mm to about 1 meter. Portable air cleaners are in the smaller size of these ranges and typically weigh about 3 to about 50 pounds, preferably not more than 30 pounds. Such portable air cleaners also typically comprise fans to create an airflow through the electrostatic precipitator, suitable circuitry to generate the corona voltage, e.g. about 3 kV to about 35 kV, and the potential difference at the driver electrode, a circuit to control the general functions such as the fans speed and timers, user interface circuits, and a protective housing and guards having an inlet and an outlet to allow air movement but preventing access to the high voltage parts and the fan(s). The preferred portable air cleaners of the present invention comprise readily removable and reinsertable collector electrodes, and/or receptor/collector electrodes, to facilitate cleaning. The preferred portable air cleaners of the present invention are also self contained. As used herein, the term “self contained” is used to indicate that all elements of the air cleaner are advantageously located in a portable unit either inside or on a housing, with the possible exception of a power supply and/or power cord for connecting the self contained unit to a source of electrical power.

For example, an air cleaner suitable for a room of about 300 square feet can be provided with approximately ten tungsten wire emitters, each having a length of about 0.5 meters. The emitters are positioned proximate to receptor/collector electrodes, for example as shown in the arrangement of FIG. 10, for a total of eleven receptor/collector electrodes. From the present description and drawings, one of ordinary skill can determine suitable spacing between the emitter and receptor. A voltage gradient of 0.7 kV/mm to 1.2 kV/mm (potential difference between the emitter and receptor electrode in kV/the spacing in mm) between the emitter and the unshielded regions of the receptor has been found to give good results. An example of suitable receptor/collector electrodes are generally rectangular plates, formed of aluminum, having dimensions of about 0.1 meters by about 0.5 meters by about 0.5 mm in thickness. Such receptor/collector electrodes can be separated by about 5 to about 30 mm, preferably about 12 mm. Corresponding driver electrodes, can, for example, also be generally rectangular, having dimensions of about 60 mm by about 0.5 meters by about 0.5 mm in thickness positioned between each pair of receptor/collector electrodes, i.e. a total of ten driver electrodes. Such a portable, room-type air cleaner can support an air flow through-put rate of about 200 cubic feet per minute and a corona current of about 150 microamperes, utilizing suitable circuits to establish a voltage potential of about 13 kV between the emitters and receptor/collector electrodes. Larger indoor air cleaners can circulate about 6,000 cubic feet per minute for areas of 6,000 to about 13,000 square feet.

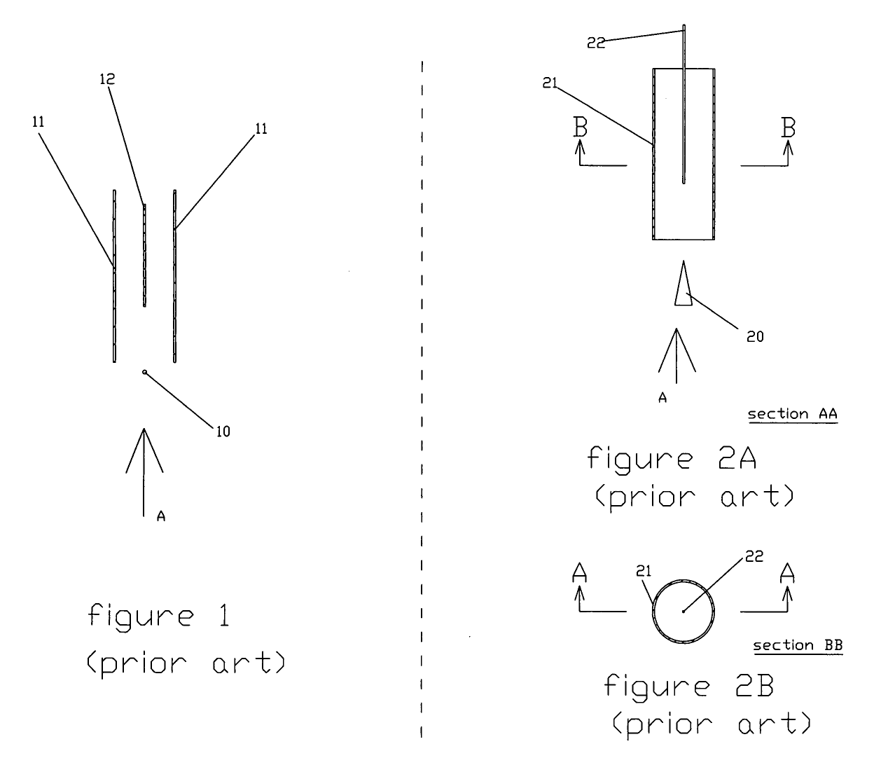

For purposes of comparison with various embodiments of the present invention, FIGS. 1, 2A, 2B and 11 are provided to illustrate structures known in the prior art.

FIG. 1 illustrates an emitter 10, a pair of receptor/collector electrode plates 11, and a driver electrode 12. This type of electrostatic precipitator can be used with or without a mechanically induced airflow, e.g. from a fan. According to this type of prior art device, the other components of which are not illustrated, when a sufficient electric potential difference is established between emitter 10 and receptor/collector electrode plates 11, a corona is formed, i.e., an ionization current flows from emitter 10 to receptor/collector plates 11. Entrained particles in the air passing through the corona become charged and are attracted toward receptor/collector electrode plates 11. A driver electrode 12, preferably having the same type charge, i.e. positive or negative, as emitter 10 enhances and accelerates the charged particles toward collection areas on electrodes 11.

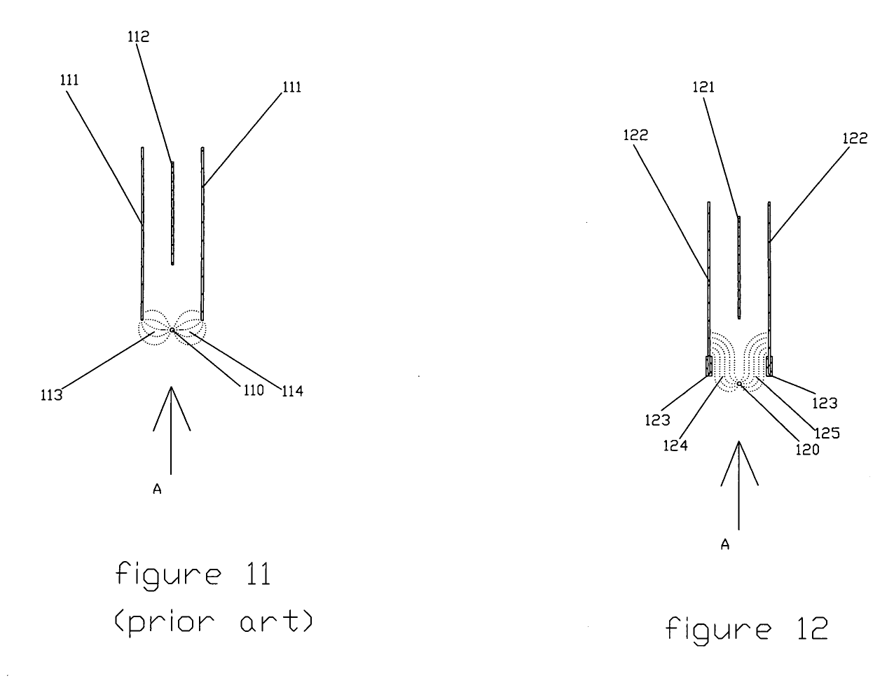

FIG. 11 illustrates, in dotted line fashion, the path of the majority of the ionization current between emitter 110 and receptor/collector electrode plates 111. While some of the ionization current is likely to flow to portions of receptor electrode 111 further downstream than the upstream edge, the ionization current is not uniformly distributed, but will concentrate at the upstream edges. As noted above, this non-uniform ionization current density results in the production of greater amounts of ozone than would a more uniform current density. The illustrated lines of flux are conceptual graphics and are not intended to represent an actual plotting of the ionization current, but will assist in differentiating embodiments of the present invention from the prior art.

FIGS. 2A and 2B are cross-sectional longitudinal and end views, respectively, of an alternative embodiment of previously known electrostatic precipitator air cleaners wherein an emitter 20 is a pin-type emitter having a small point positioned proximate the opening of a tubular receptor/collector electrode 21. Additionally, a driver electrode 22 in the form of a wire is positioned downstream and at least partially within the tubular collection region of the tubular electrode 21. FIG. 2A is a cross-sectional view along lines A-A of FIG. 2B while FIG. 2B is a cross-sectional view taken along lines B-B of FIG. 2A. In this embodiment, the ionization current would also concentrate on the upstream edges of the tubular receptor/collector electrode 21.

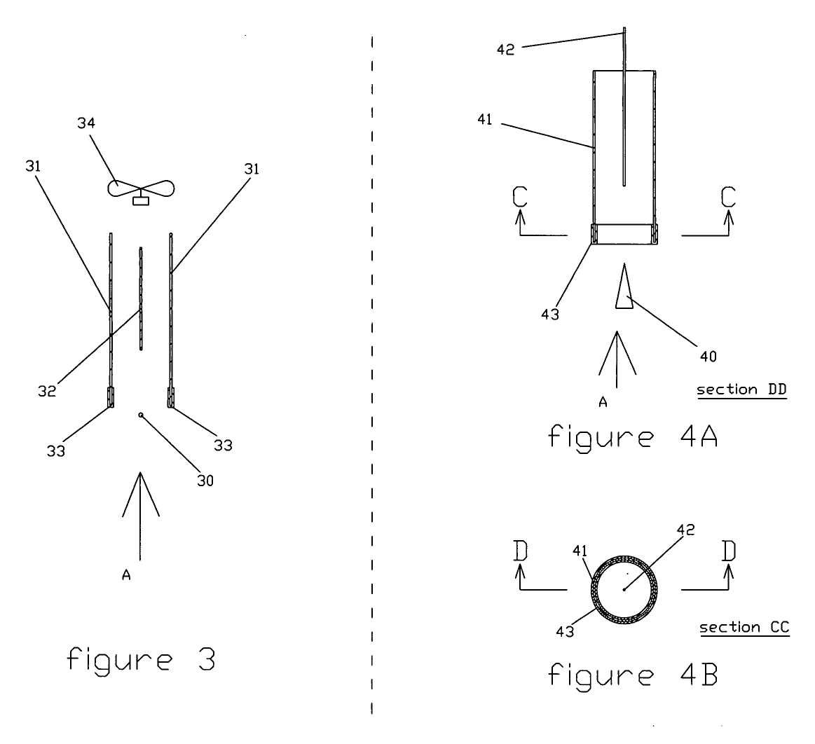

FIG. 3 illustrates one embodiment of the present invention comprising an emitter 30, receptor/collector electrodes 31 and a driver electrode 32. As used herein, the term “receptor/collector electrode” refers to a single electrode which provides both an ionization section for reception of an ionization current from an emitter, i.e. the “receptor” or “ionization” section, as well as a “collector” section which is used herein to refer to an unshielded portion of an electrode opposite a driver electrode. Typically, the majority of the collected particles accumulate in the “collector” section. From the present description, those skilled in the art will appreciate that there may be some overlap since some charged particles will collect in the ionization section of the electrodes and ionization current may, in certain embodiments, flow to portions of an electrode opposite a driver electrode. However, due to the larger surface area of the typical collector section relative to the unshielded portion of the receptor section, the majority of the collected particles will typically collect in the portions referred to herein as the collector sections. According to this illustrated embodiment of the present invention, the upstream edges of receptor/collector electrodes 31 are covered with insulators 33. As illustrated, the insulation wraps entirely around the upstream edges of these plate electrodes 31 and extends downstream for some distance. For purposes of reference, the terms “upstream” and “downstream” refer to the direction of airflow as indicated by the arrow A in some of the figures. This embodiment is illustrated with a downstream fan 34 which draws air in the direction of arrow A. According to this embodiment of the present invention, the edges of the electrode plates 31 closest to wire emitter 30 are covered with an insulator 33. For example, for a portable, household, room-type air cleaner of the type described above, a polyester film of about 0.05 mm to about 0.25 mm thick having a volume resistivity of 1.0×10¹³ ohm-cm works well for a corona potential of about 3 kV to about 35 kV.

FIGS. 4A and 4B illustrate another embodiment of the present invention wherein a pin-type emitter 40 is positioned slightly upstream of the upstream end of a tubular receptor/collector electrode 41. According to this embodiment, the edge and upstream end portion of the tubular receptor/collector electrode 41 closest to the emitter is covered with insulation 43. The insulation 43 may be of the type described above and preferably extends along both the inner and outer surfaces of the tubular receptor/collector electrode 41. The distance that the insulation extends downstream on the electrode can be varied depending on the size of the electrodes, spacing and electrical parameters.

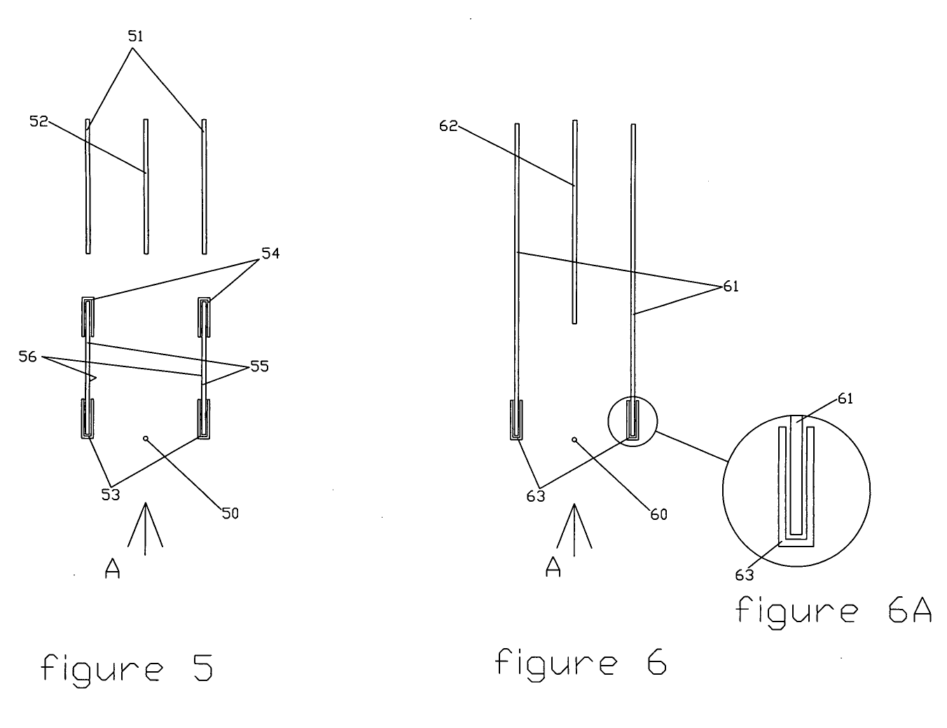

FIG. 5 is a top view of an alternative embodiment of the present invention wherein emitter 50 is positioned proximate an imaginary line connecting the upstream edges of a pair of plate-type receptor electrodes 55. According to this illustrated embodiment, the receptor electrodes 55 are insulated along both the upstream and downstream longitudinal edges and end portions. The upstream insulation 53 and downstream insulation 54 on both receptor electrode plates defines an intermediate, unshielded current accepting surface 56 on each plate 55. If the downstream edges of the receptor electrodes 55 are spaced sufficiently from the emitter 50, the effect of insulating them is small. However, since edges often contain micro structures with very small radii, these structures can interact with the corona resulting in some current concentrations which would produce more ozone. This illustrated embodiment also comprises a pair of separate collector electrodes 51 and a driver electrode 52 positioned further downstream.

For simplicity, and cost efficiency, it is most preferable that the unshielded region of the receptor electrode and the unshielded region of the collector electrode are at the same, or at least very close, electrical potentials.

In the embodiment of FIG. 5, the driver 52 is illustrated as having the same length as the collector electrodes 51, and generally in alignment with the edges of each of these collector electrode plates. In order to achieve the benefits of the present invention, it is not necessary that the driver electrode 52 have the same length or width as the collector plates 51 or that the edges of the driver 52 be aligned with the edges of the collector plates 51.

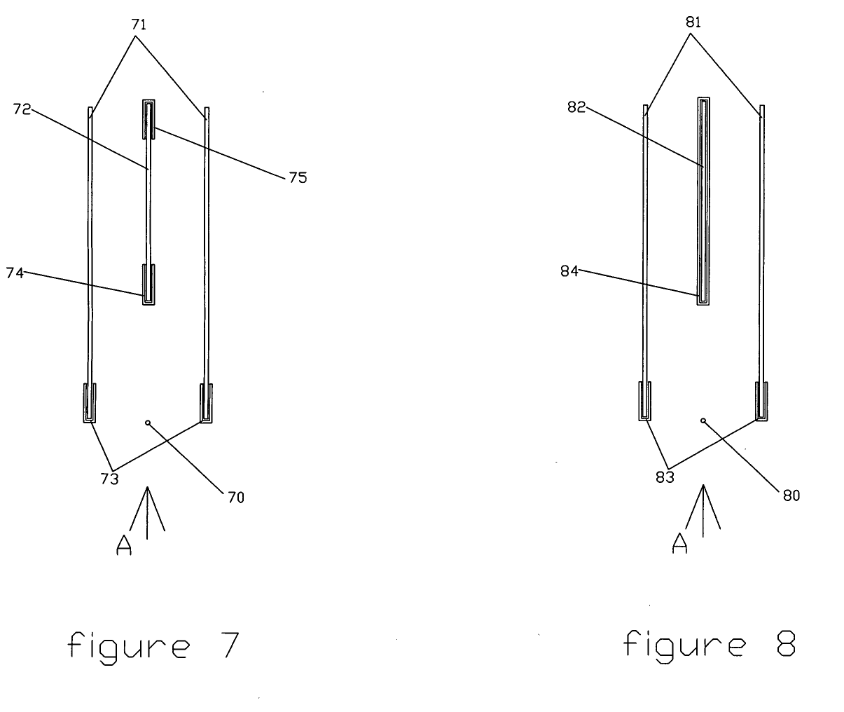

FIG. 6 is a top view of an alternative embodiment of the present invention where a pair of receptor/collector electrode plates 61 serve as both the receptor electrodes for the ionization section as well as collector electrodes. From the present description and drawings, those skilled in the art will appreciate that some precipitation of charged dust and/or other particles will typically occur in the ionization section as well as in any intermediate section between the ionization section and the collector section, however, most of the ionization of particles will occur in the ionization section while most of the particle precipitation will occur in the collector section.

According to this illustrated embodiment, and as shown more clearly in FIG. 6A which is an enlarged partial view of the upstream edge of the right receptor/collector electrode 61, according to this embodiment of the present invention, insulation 63 is spaced from the surface of the receptor/collector plate 61. This insulation 63 can be positioned either closer or further from receptor/collector plates 61, but is preferably not more than 0.5 mm from the shielded surface or the spacing between the insulation and the emitter is preferably not greater than 5% of the distance between the emitter and the shielded portion of the receptor electrode. Insulation 63 can be supported in any desired manner, such as by position pads formed of insulating material positioned between the insulation 63 and receptor/collector plate 61 and secured with a suitable adhesive. Alternatively, the insulator can be formed slightly longer than the edge of the electrode to be shielded. The ends of the insulator can be joined, for example with a heat seal, leaving a channel allowing the insulator to be slid over the electrode. Additionally, the insulator can be simply formed as a channel which is clipped onto the edge of the electrode. According to other embodiments of the present invention, the space between the electrode and the insulation need not be uniform along the entire length of the shielded section. The effect of the ionization current going around the gap between the insulator and receptor is small if the gap is narrow as compared with the corona gap. The insulation can also be provided in other forms, such as curved, e.g. concave or convex, if desired.

FIGS. 7 and 8 illustrate alternative embodiments of the present invention similar to the embodiment illustrated in FIG. 6, however, in FIG. 7 a driver electrode 72 is provided with insulation 74 on the upstream edge and insulation 75 on the downstream edge, while in FIG. 8 the entire driver electrode 82 is covered with insulation 83. Covering the edges of the driver electrode with insulation further reduces the likelihood of arcing.

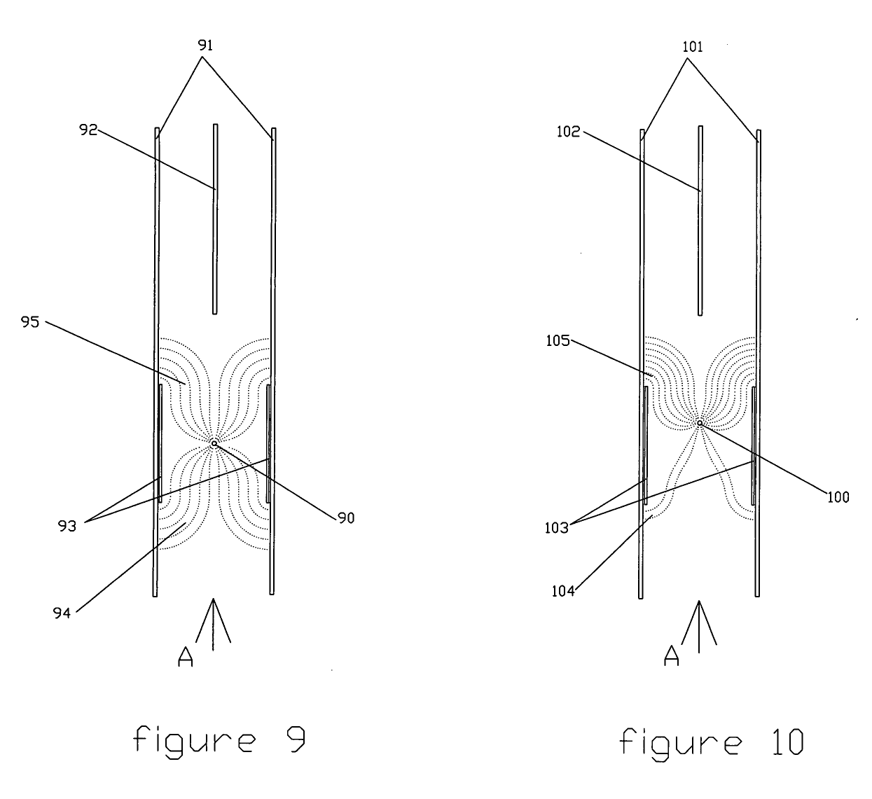

FIGS. 9 and 10 illustrate alternative embodiments of the present invention wherein an emitter electrode is positioned between the ionization sections of two insulated portions of receptor/collector electrodes. According to these embodiments, the portions of the receptor/collector electrodes closest to the emitters do not have changes in curvature or changes in continuity. According to the embodiment shown in FIG. 9, an emitter 90 is positioned between insulated portions of a pair of receptor/collector electrode plates 91. According to this embodiment, the surfaces of the receptor/collector plates 91 closest to emitter 90 are insulated effectively preventing the establishment of a significant ionization current between the emitter 90 and the portions of the receptor/collector plates 91 which are shielded by insulation 93. It will be appreciated by those skilled in the art that it is very difficult to measure the current passing through an insulator of the type described herein and shown in the figures. It is possible that minute amounts of ionization current could flow from the emitter to insulation 93. In an ideal situation there will be no ionization current flowing from the emitter directly to the portions of the receptor/collector electrodes 91 which are shielded by insulation 93. According to this illustrated embodiment, the corona will be established between the emitter 90 and the unshielded portions of the receptor/collector electrodes upstream and downstream of the insulation 93. As used herein, the term “unshielded” indicates that the surface of the electrode referred to is not shielded by “insulation” or an “effective resistor” as defined herein. It is preferred that the “unshielded portion” of the receptor section is totally exposed to receive the ionization current from an emitter, however, the benefits of the present invention would not be eliminated by placing a material with some lesser degree of resistivity than the “insulation” or “effective resistor” in either the receptor section, or even in the ionization section. It is also preferred that the collector section is exposed without any resistive material blocking the surface on which the dust or other particles will precipitate, other than previously collected dust or particles. Unlike some of the collector electrodes of the prior art, the preferred electrodes utilized with the present invention are stationary with respect to emitters. During the collection process, the electrical potential applied to the collector section is sufficient to maintain an electric field which is attractive to the charged particles while also discharging those particles as they contact the collector electrodes. The collector sections are, therefore, advantageously designed to avoid the accumulation of electric charge from the ionized particles as those particles are continuously collected without using any supplemental discharging technique that periodically acts directly on the collecting surfaces, such as a grounded brush. Such accumulation of charge would tend to lessen the attractive field of the collector sections and could divert subsequent particles having the same charge.

According to this embodiment illustrated in FIG. 9, an airflow is being induced in the direction of arrow A by some mechanism other than electrostatic induction, such as a fan (not shown).

The dotted lines 94 and 95 illustrate the probable flow of the ionization current from emitter 90 to the unshielded, ionization section of receptor/collector electrodes 91. As indicated, this embodiment of the present invention provides the advantage of establishing a corona which is more spread out and, therefore, particles in the air remain in the corona for a longer period of time, thereby increasing the amount of charge and/or the percentage of particles which receive any charge from the corona, thereby increasing the collection efficiency of the air cleaner. This embodiment also comprises a driver electrode 92 and a collector section on the receptor/collector electrode 91, on which the majority of collected particles will be deposited. While FIG. 9 is shown with unitary receptor/collector electrodes, it is also within the scope of the present invention to utilize an emitter positioned between insulated portions of flat plate receptor electrodes and providing separate electrodes on which particles will collect, with or without a driver electrode, further downstream, similar to the embodiment shown in FIG. 5.

FIG. 10 illustrates an alternative embodiment of the present invention, similar to that shown in FIG. 9, however, the emitter 100 is positioned further downstream, but still between shielded portions of the receptor/collector electrodes 101. According to this embodiment, an emitter 100 is positioned between portions of receptor/collector electrodes 101 shielded with insulation 103. According to this embodiment, the emitter 100 is positioned downstream about 75% of the length of the insulation 103, as measured from the upstream end of the insulation 103. The exact position of the emitter relative to the insulation can be varied without departing from the scope of the present invention. As noted above with respect to FIG. 9, it is most preferred that no significant amounts of ionization current flow through insulation 103. FIG. 10 generally illustrates the likely flow of ionization current between emitter 100 and the unshielded portions of receptor/collector electrode 101. As indicated, due to the positioning of the emitter 100 further downstream, more of the ionization current will flow to the unshielded portions of the receptor/collector electrodes 101 located downstream of insulation 103. However, some of the ionization current will likely flow to the portions of the receptor/collector electrodes 101 located upstream of the insulation 103. If the emitter is moved further downstream, then the amount of ionization current and/or the likelihood that ionization current will flow to the unshielded portions upstream of the insulation 103 will decrease.

FIGS. 11 and 12 illustrate the electrostatic precipitators of FIGS. 1 and 3, respectively, with dotted lines showing likely paths of the majority of the ionization current. FIG. 12 gives an idea of some of the paths of ionization current as a result of the addition of the insulators as compared to the prior art shown in FIG. 11. As with the dotted lines showing ionization current in other figures, the dotted lines in FIGS. 11 and 12 are conceptual graphics provided to assist in the visualization of the approximate differences between the present invention and the prior art and are not an actual plotting of the ionization current. In the prior art configuration illustrated in FIG. 11, more of the ionization current will be attracted to the edges of receptor/collector plates 111 closest to emitter 110 than to other areas on the receptor/collector plates 111. Therefore, the ionization current density will not be uniform. With respect to FIG. 12, the insulation 123 shields the upstream edges and end portions of receptor/collector plates 122 so the ionization current indicated by dotted lines 124 and 125 will tend to be more uniformly spread over the adjacent, unshielded flat portions of the receptor/collector plates 122. According to the configuration shown in FIGS. 11 and 12, the actual path of the ionization current from the respective emitters to the respective receptor/collector plates will also be longer when insulation 123 is used. This increases the amount of time that particles entrained in the airflow will encounter the ionization current and thereby more effectively charge these entrained particles thereby enhancing the collection efficiency.

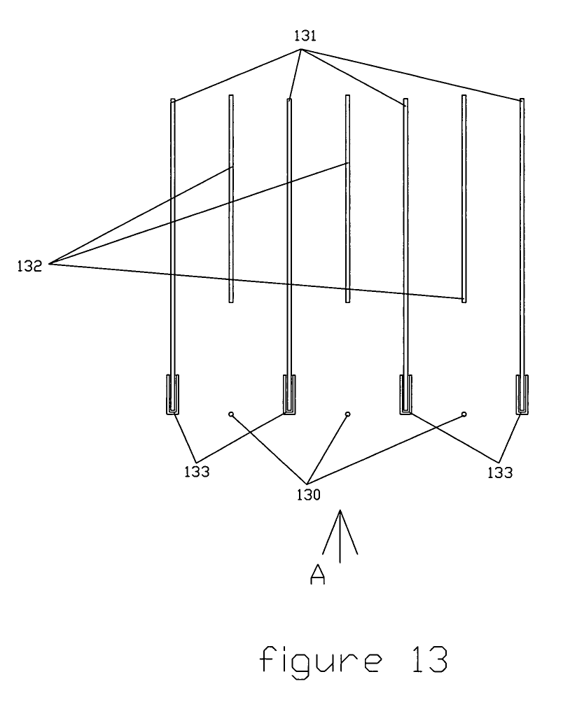

FIG. 13 illustrates an embodiment of the present invention which utilizes a plurality of emitters 130 positioned proximate a plurality of receptor/collector electrode plates 131 having insulation 133 positioned proximate their upstream edges.

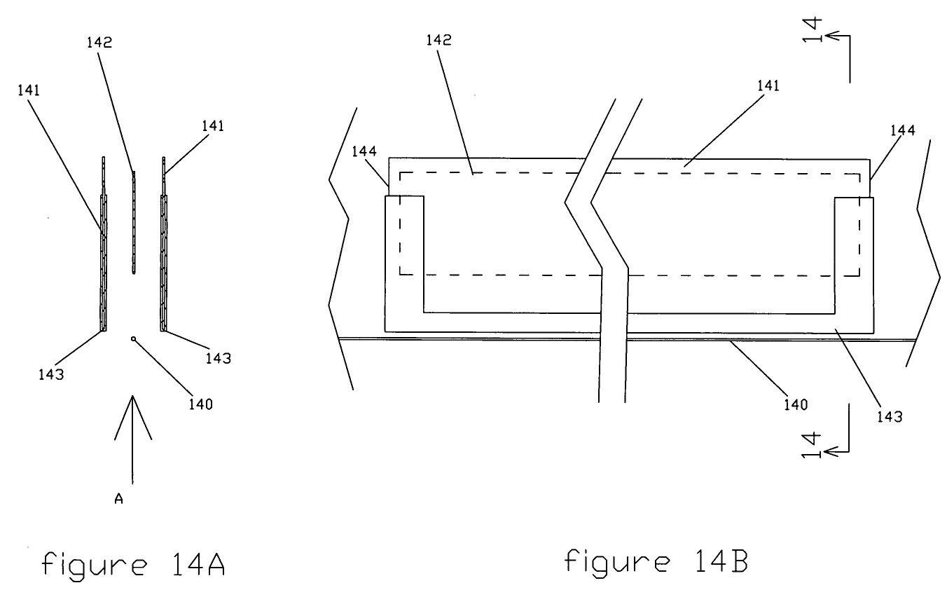

The positioning of the insulation in the various embodiments of the present invention is ideally designed to minimize ionization current concentrations on the receptor electrodes. FIGS. 14A and 14B are a cross-sectional edge view and a side view of an embodiment of the present invention wherein insulation 143 on receptor/collector electrode plate 141 is provided along the entire longitudinal edge portion closest to emitter 140 and on portions of the top and bottom transverse ends 144. According to this illustrated embodiment, the portion of the insulation 143 on transverse end portions 144 extends into the collector section of the receptor/collector electrodes 141 near driver electrode 142 (shown in phantom in FIG. 14B). While the illustrated insulation 143 extends for a majority of the length of transverse ends 144, it is also within the scope of the present invention for the insulation to extend halfway or less than halfway along one or both transverse ends 144.

From the present description and drawings, it will be appreciated that according to different embodiments of the present invention, the emitter can be positioned between portions of one or more receptors, or at a location which is not between portions of one or more receptors. In the case of a tubular receptor electrode, the emitter could be positioned either inside the volume of the tube defined by the receptor electrode or outside of that tube. With respect to plate receptor electrodes which are typically generally planar, an emitter can be positioned between two receptor electrodes or at a position which is not between two receptor electrodes. It is also within the scope of the present invention to utilize receptor electrodes of different configurations.

Additionally, the emitter may be positioned generally parallel to a longitudinal edge of a receptor electrode, or can be positioned such that the emitter is not generally parallel to a longitudinal edge. In one preferred embodiment of the present invention which utilizes a wire-type emitter, the wire emitter lies in a plane which is generally parallel to a longitudinal edge of the receptor electrode. According to another embodiment, the longitudinal axis of a wire-type emitter is generally parallel to the longitudinal edge of the insulation defining the boundary between the shielded portion and unshielded portion of a receptor electrode.

FIG. 15 illustrates a further embodiment of the present invention comprising an emitter 150, a pair of receptor/collector electrodes 151 each provided with insulation 153 positioned proximate and around their upstream edges so that the insulation 153 covers a portion of the inner and outer surfaces at the upstream ends of receptor/collector electrodes 151. In addition, further downstream in the collector section, two additional collector electrodes 154 and three driver electrodes 152 positioned between the adjacent collector electrodes 151, 154 are provided within the air stream. Therefore, according to this illustrated embodiment, the corona is established between an emitter 150 and two receptor/collector electrodes 151, but the collector section comprises four collector electrodes 151, 154. According to this embodiment of the present invention, the number of collector electrodes in the collector section is more than the number of receptor electrodes which interact with the emitter to establish the corona. It is also within the scope of the present invention to establish a corona between a single emitter and receptor electrode, while having one or a plurality of collector electrodes positioned further downstream. Also, while the embodiment shown in FIG. 15 utilizes two, unitary receptor/collector electrodes 151, it is also within the scope of the present invention to have separate receptor electrodes and collector electrodes, such that only one or neither of the receptor electrodes is a unitary structure with an electrode which extends into the collector section.

It is also within the scope of the present invention to shield the very edge of a receptor electrode and a portion of one surface of that receptor electrode adjacent to that edge.

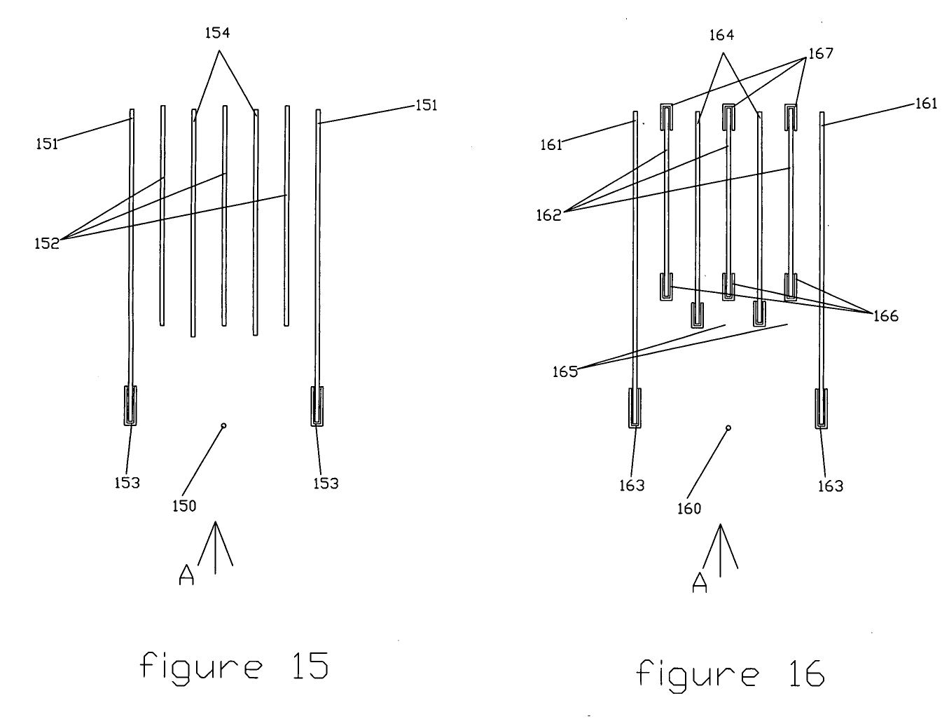

FIG. 16 illustrates an alternative embodiment of the present invention of the same general configuration as that shown in FIG. 15 but wherein the upstream ends of additional collector electrodes 164 and both ends of driver electrodes 162 are shielded. According to the embodiment shown in FIG. 16, an emitter 160 is positioned to create an ionization current with receptor/collector electrodes 161. The upstream edges of receptor/collector electrodes 161 closest to emitter 160 are shielded with insulation 163 which extends along the inner and outer surfaces of receptor/collector electrodes 161 for a short distance, e.g. about 2-about 50 mm, preferably about 10-20 mm. Additional collector electrodes 164 are similarly shielded with insulation 165 at their upstream edges. Furthermore, driver electrodes 162 are shielded with insulation 166 at their upstream edges and insulation 167 at their downstream edges. Relative to the embodiment shown in FIG. 15, the embodiment of FIG. 16 is even less likely to have arcing and non-uniform current density concentrations, if other parameters are maintained the same.

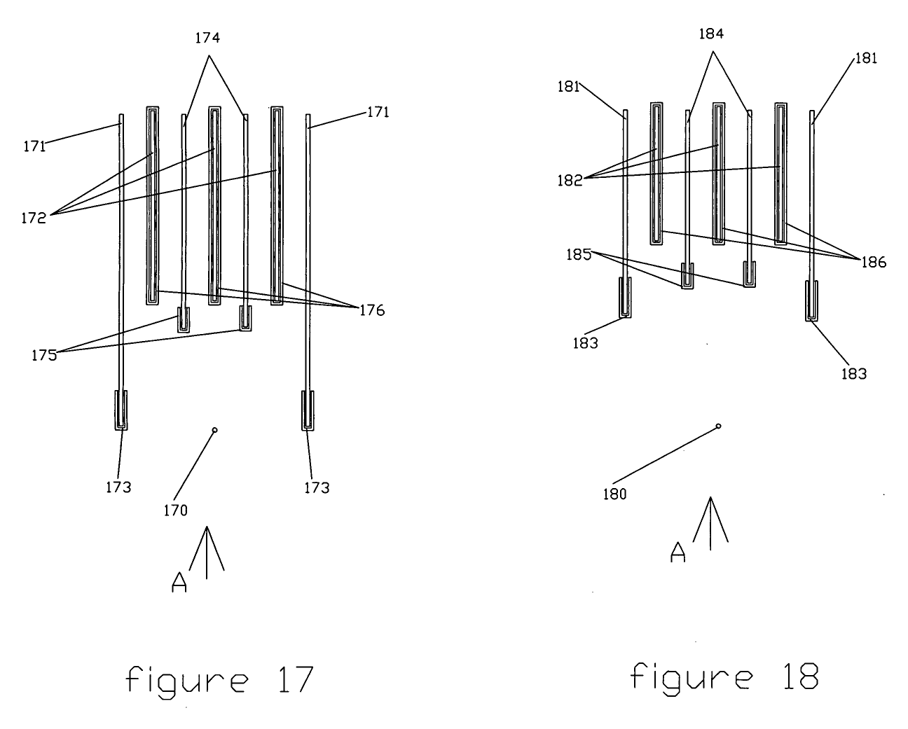

FIG. 17 illustrates a still further embodiment similar to the embodiment shown in FIG. 16, however, the driver electrodes 172 are entirely shielded by insulation 176. According to this embodiment, emitter 170 is positioned proximate receptor/collector electrodes 171 having their ends closest to emitter 170 shielded by insulation 173. Additional collector electrodes 174 located further downstream in the collector section have their upstream end portions shielded by insulation 175, while three driver electrodes 172 are entirely shielded by insulation 176. This embodiment provides even further safeguards against undesirable arcing and allows a higher potential difference to be applied between driver electrodes 172 on the one hand, and receptor/collector electrodes 171 and collector electrodes 174, on the other hand.

FIG. 18 illustrates a still further embodiment of the present invention wherein a single emitter is utilized with more than two receptor electrodes to establish ionization currents between the emitter and more than two receptor/collector electrodes. According to this embodiment, emitter 180 is positioned upstream of four collector/receptor electrodes designated 181 and 184. An outer pair of receptor/electrodes 181 are positioned slightly more upstream than an inner pair of receptor/collector electrodes 184. Additionally, the upstream edge portions of each of receptor/collector electrodes 181 and 184 are shielded by insulation 183 or 185, respectively. Unshielded surfaces of each of these receptor/collector electrodes 181 and 184 are positioned such that an ionization current will flow between these unshielded surfaces and emitter 180. While this drawing is not to scale, the distance between the unshielded portions of receptor/collector electrodes 181 and emitter 180 is preferably close to the distance between the unshielded portions of receptor/collector electrodes 184 and emitter 180. For example, the difference between these two distances is preferably no more than about 5 to 30 mms for a portable air cleaner. According to this illustrated embodiment, three driver electrodes 182 have both of their longitudinal edges and both surfaces entirely shielded with insulation 186.

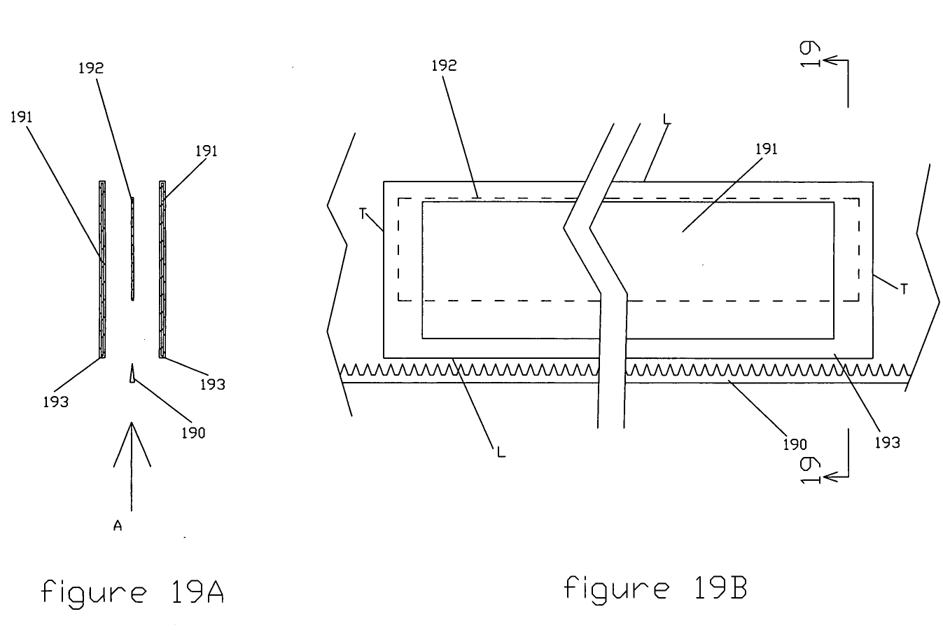

FIGS. 19A and 19B are a cross-sectional edge view and a side view, respectively, of a still further embodiment of the present invention. According to this embodiment, emitter 190 is formed with a large number of pinpoints. The drawings are illustrative only and are not intended to limit or accurately depict the actual shape of the pinpoints of emitter 190. Those skilled in the art will appreciate that various forms of pinpoint emitters are known. Additionally, while it is preferred that the pinpoints of emitter 190 are all connected, it is also within the scope of the present invention to provide a plurality of electrically discrete pinpoint emitters 190 with the same or different electrical potentials.

According to this illustrated embodiment of the present invention, receptor/collector electrode 191 is a generally rectangular plate having longitudinal edges L and transverse edges T. Longitudinal edges L and transverse edges T are shielded with insulation 193 which extends a short distance onto both surfaces of the receptor/collector electrodes 191 as best shown in FIG. 19B. A major portion of receptor/collector electrode 191 is not shielded by insulation 193 and is, therefore, exposed for the flow of ionization current between these unshielded regions and emitter 190. As with the other illustrated embodiments, a driver electrode 192 (illustrated in phantom in FIG. 19B) is positioned between the receptor/collector electrodes 191 toward the downstream ends of those receptor/collector electrodes.

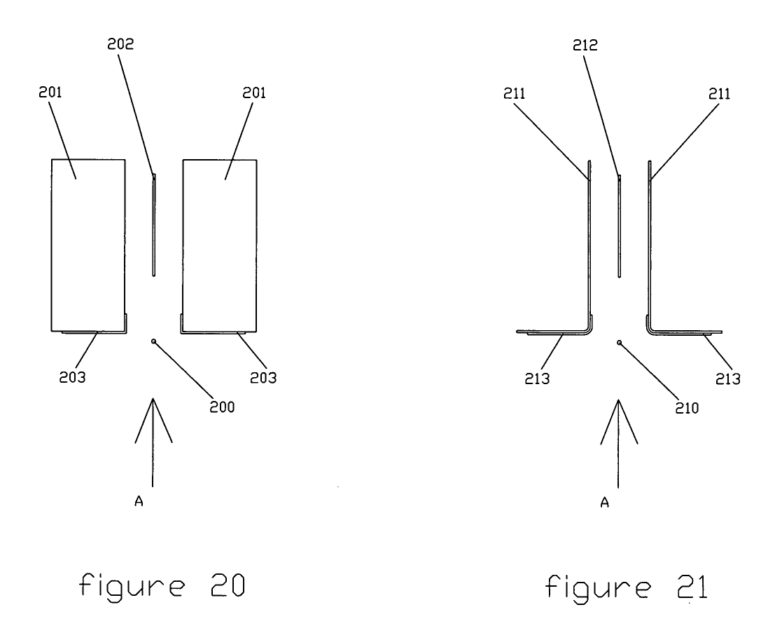

FIG. 20 illustrates an alternative embodiment of the present invention comprising a wire-type emitter electrode 200, two receptor/collector electrodes 201 and a driver electrode 202. The receptor/collector electrodes 201 of this embodiment are generally in the form of blocks. Insulation 203 is positioned to shield portions of the longitudinal surfaces as well as portions of an upstream transverse surface of each of receptor/collector electrodes 201.

FIG. 21 illustrates an alternative embodiment of the present invention comprising a wire-type emitter 210, two curved plate receptor/collector electrodes 211 and a driver electrode 212. According to this embodiment of the present invention, the receptor/collector electrodes 211 are in the form of angled plates wherein a transverse portion lies at an angle to the longitudinal portion of the electrodes which also forms the collector section. According to this embodiment of the present invention, the transverse portions of electrodes 211 are generally perpendicular to the longitudinal portions, however, these portions can be positioned at either greater or lesser angles. Insulators 213 shield portions of the transverse and longitudinal surfaces of the electrodes 211 closest to emitter 210.

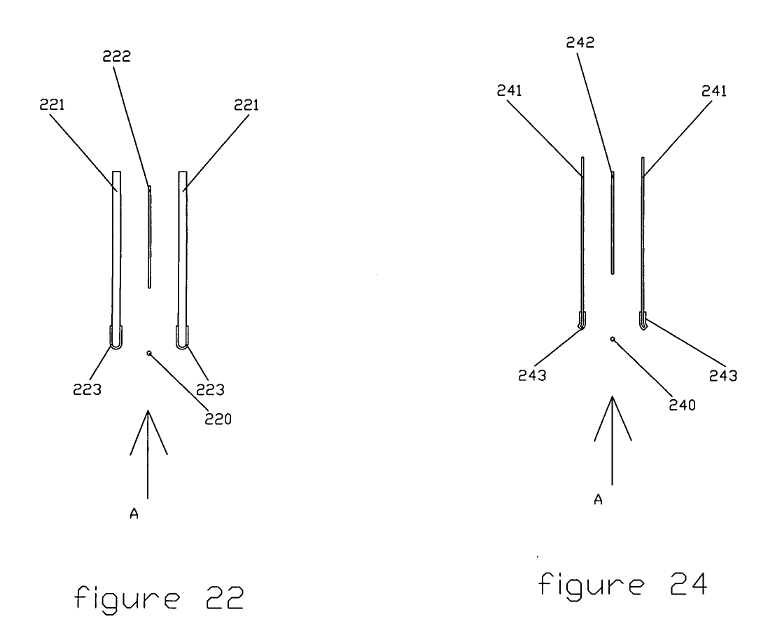

FIG. 22 illustrates a still further embodiment of the present invention wherein receptor/collector electrodes 221 are formed as plates, e.g. having a thickness of about 5 mm, and having rounded upstream end portions which are shielded by insulators 223.

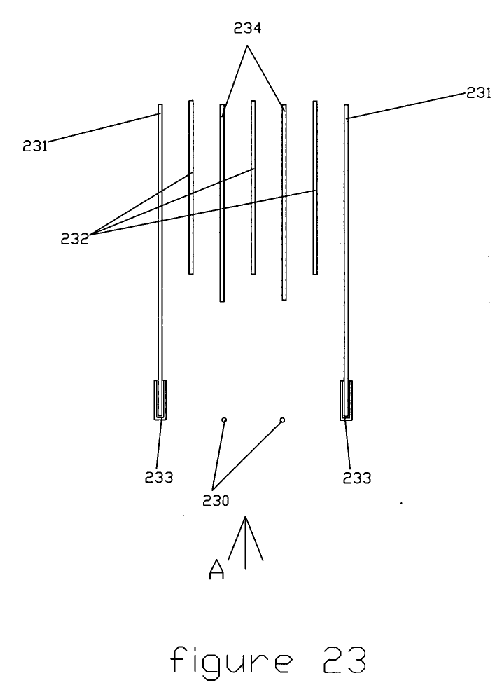

FIG. 23 illustrates a still further embodiment of the present invention wherein a plurality of wire-type emitters 230 are positioned between a pair of plate-type receptor/collector electrodes 231 having upstream end portions shielded by insulators 233. While this illustrated embodiment shows two emitters utilized with two plate-type receptor/collector electrodes 231 and a plurality of additional collector electrodes 234 and driver electrodes 232 positioned in the collector section, more than one emitter can also be used with other embodiments of the present invention such as those illustrated herein.

FIG. 24 illustrates a further embodiment of the present invention wherein the upstream end portions of two plate-type receptor/collector electrodes 241 are curved. According to this embodiment of the present invention, the portions of receptor/collector electrodes 241 comprising a change in curvature, i.e. a bend, and the portions which comprise a change in continuity on the surface, i.e. the upstream edges, are shielded by insulators 243. As indicated, this embodiment also comprises a wire-type emitter 240 and a driver electrode 242.

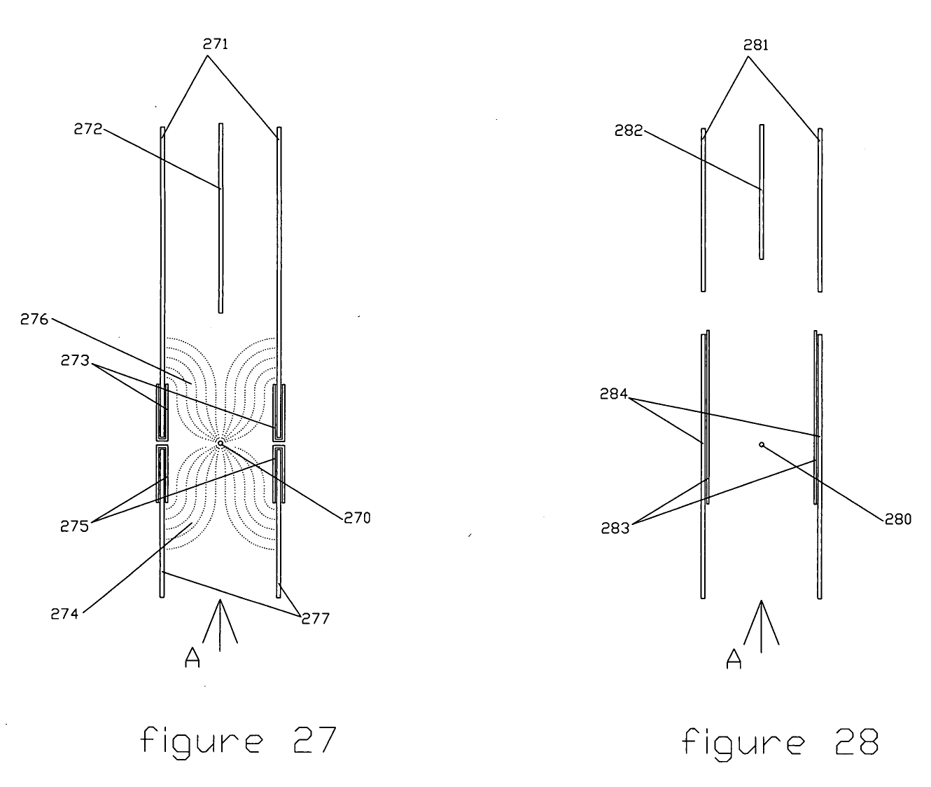

FIG. 27 illustrates an alternative embodiment of the present invention wherein a wire emitter 270 is positioned generally between four electrodes including a pair of receptor electrodes 277 and a pair of receptor/collector electrodes 271. As illustrated, each illustrated receptor electrode 277 has a downstream end portion shielded by insulation 275. Closely spaced to the downstream end of each receptor electrode 277 is the upstream end of receptor/collector electrode 271 which is insulated by insulation 273. According to this embodiment, ionization current 274 flows to the unshielded portion of receptor electrodes 277 upstream of insulation 275, as well as to the unshielded portion of receptor/collector electrode downstream of insulation 273. An advantage of this arrangement is that the voltage of electrodes 277 and 271 can be different for optimizing the collection efficiency.

FIG. 28 illustrates a still further embodiment of the present invention wherein insulation 283 shields portions of receptor electrodes 284. In this illustrated embodiment, insulation 283 extends beyond the downstream end of receptor electrodes 284 in order to shield the downstream edges of receptor electrodes 284 from ionization current. This embodiment also comprises spaced collector electrodes 281 and driver electrode 282.

FIG. 29 illustrates a further embodiment of the present invention wherein wire emitter 290 is positioned between a portion of receptor/collector electrodes 291 having a change in curvature. As illustrated, some ionization current 294 flows upstream of insulation 293 while some ionization current 295 flows to unshielded portions of electrodes 291 downstream of insulation 293. This embodiment also comprises a driver electrode 292.

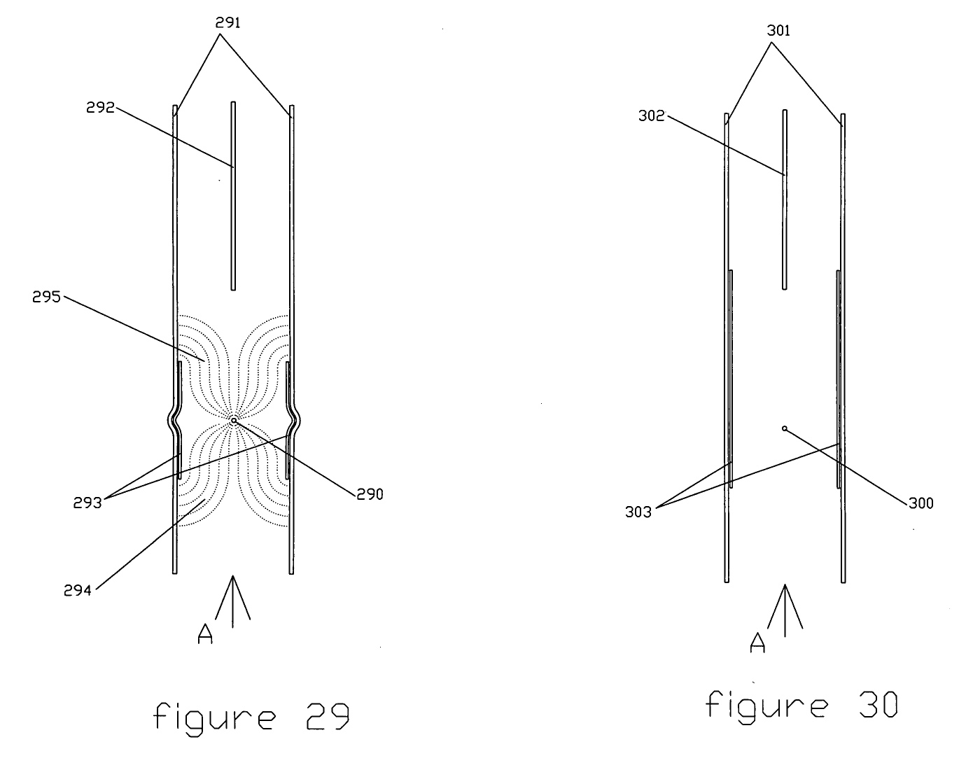

FIG. 30 illustrates a still further embodiment similar to that shown in FIG. 29, however, receptor/collector electrodes 301 do not have a change in curvature and driver 302 overlaps insulation 303, i.e. a shielded portion of the receptor-electrode, in the ionization section.

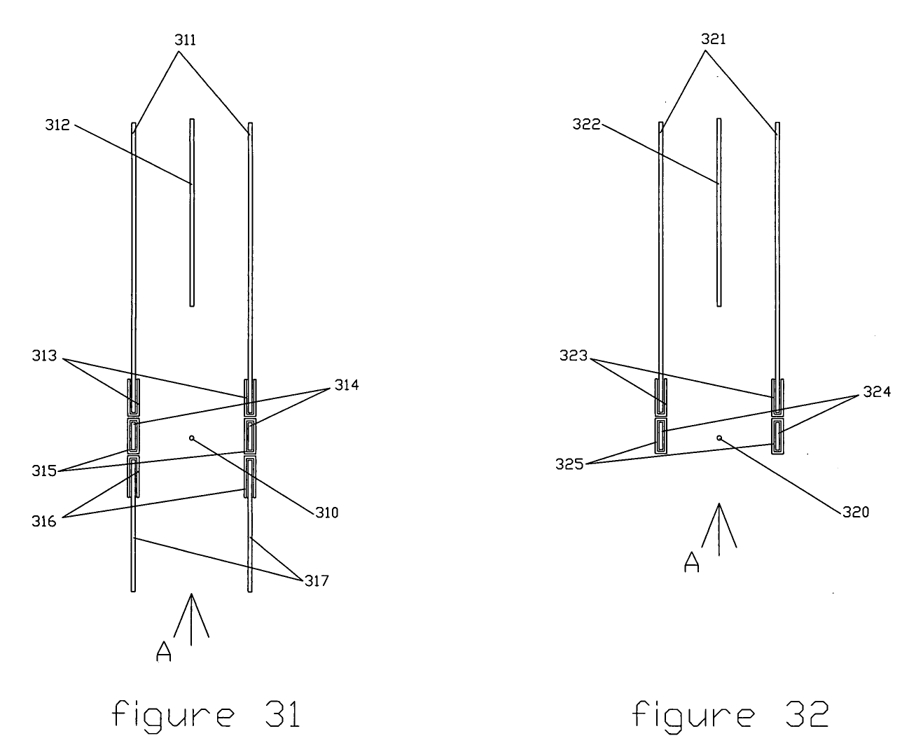

The embodiments of FIGS. 31, 32, 34 and 35 comprise additional, separate electrodes which are shielded by insulation on both surfaces and ends, and which shield other receptor electrodes. The separate electrodes can be electrically connected to receptor/collector electrodes so that they function similar to a single receptor electrode. Alternatively, these additional electrodes can be provided with different potentials to provide different effects and functions.

FIG. 31 illustrates a further embodiment of the present invention similar to the embodiment of FIG. 27 but further including additional electrodes 314 which are fully insulated by insulation 315 positioned between receptor electrodes 317 having their downstream end portions insulated by insulation 316 and receptor/collector electrodes 311 having their upstream end portions insulated by insulation 313. This embodiment permits different potentials to be applied to each of the electrodes if desired.

FIG. 32 illustrates an embodiment of the present invention similar to the embodiment of FIG. 31 but without the receptor electrodes. In the embodiment of FIG. 32, receptor/collector electrodes 321 have their upstream end portions shielded by insulation 323 and electrodes 324 are totally shielded by insulation 325.

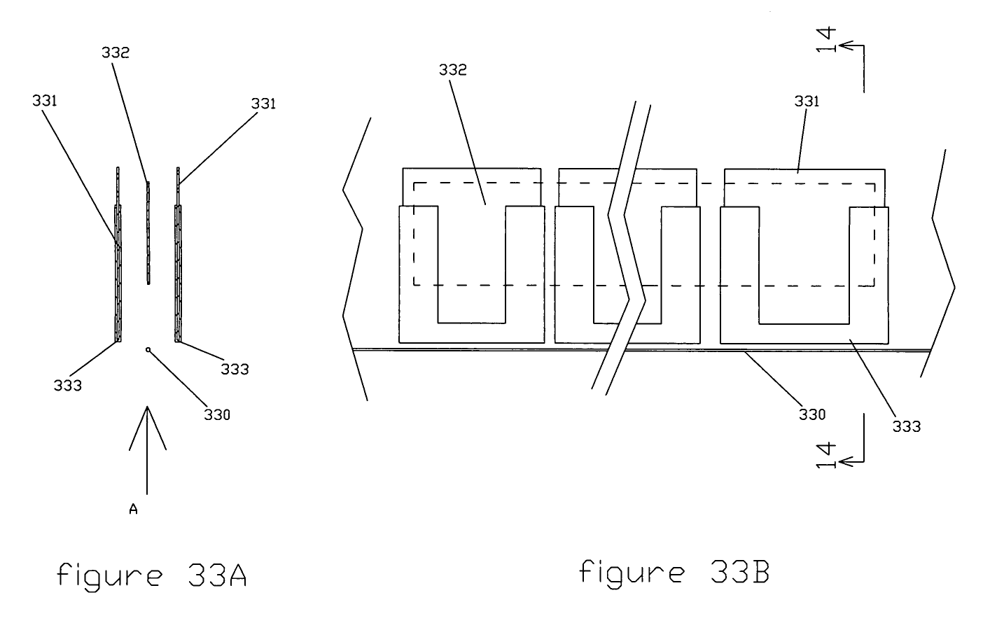

FIG. 33A and 33B illustrates two views of a further embodiment similar to the views and embodiments shown in FIGS. 14A and B. However, according to the embodiment shown in FIGS. 33A and 33B a plurality of receptor/collector electrodes are utilized. As in the embodiment shown in FIG. 14B, each of the receptor/collector electrodes 331 have their longitudinal end portions and a major portion of their transverse end portions shielded by insulation 333. A driver electrode 332 is positioned proximate the downstream portions of receptor/collector electrodes 331.

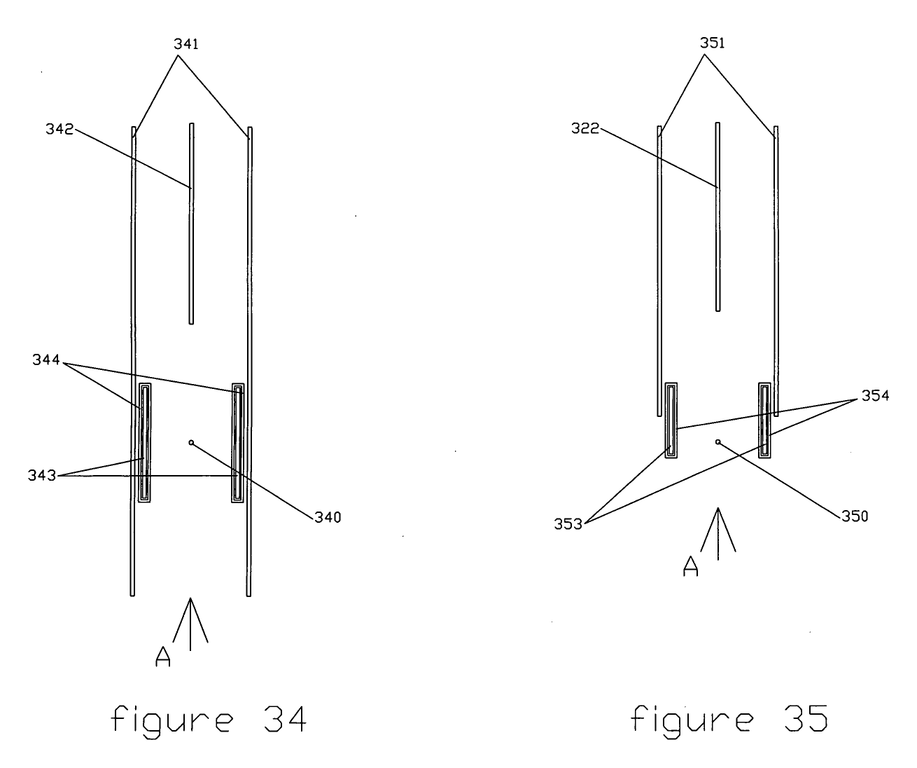

FIG. 34 illustrates a still further embodiment similar to the embodiment of FIG. 9 but wherein electrodes 343 are fully covered with insulation 344 to shield portions of receptor/collector electrodes 341. This embodiment also comprises a driver electrode 342.

FIG. 35 illustrates an embodiment of the present invention comprising receptor/collector electrodes 351, driver 322 and emitter 350. The upstream end portions of the receptor/collector electrode 351 closest to wire emitter 350 are shielded by additional electrodes 353 which are covered with insulation 354.

While the additional electrodes in FIGS. 31, 32, 34 and 35 are illustrated as being fully enclosed in insulation, it is also within the scope of the present invention to provide these additional electrodes with partial insulation depending on the size of the electrodes and the separation between the electrodes and the emitter.

While preferred embodiments of the present invention comprise insulation, other embodiments having the same general configurations as shown in the Figures are made with effective resistors shielding the same portions of the receptor electrodes, receptor/collector electrodes, driver electrodes and/or additional electrodes, as described above which are shielded by insulation. The Figures described herein also illustrate these less preferred embodiments, but with the insulation replaced by an effective resistor. As used herein, the term “effective resistor” indicates a material which has a sufficient volume resistivity and thickness to prevent at least 50% of the ionization current which flows to that electrode from flowing through that material under normal operating conditions, preferably at least 90% of that ionization current, and more preferably at least 95% of that ionization current from flowing through the effective resistor material. For purposes of these less preferred embodiments of the present invention, the insulative effect of the effective resistors are measured as follows:
For purposes of this description, the material being tested is referred to as the “designed effective resistor,” while the shielded and unshielded areas on the electrode on which the effective resistor is intended to be used in normal operation are referred to as the “designed shielded area” and the “designed unshielded area,” respectively.
1) Either some area larger than the designed shielded area of the receptor or receptor/collector electrode, or the entire electrode, is shielded, in a manner as described above, with the designed effective resistor. The whole receptor or receptor/collector electrode should be shielded with the designed effective resistor or at least the designed effective resistor should cover a larger area than the designed shielded area before applying the insulator in step #2 below so that there is some overlap of the two materials. This prevents current from flowing through the joint between the two materials. Also, by doing this, the effective insulation on the designed unshielded surface will be greater than if it was shielded by the insulator alone.
2) The designed unshielded area is then shielded with an insulator.
3) The potential difference which would be applied to the arrangement under normal operating conditions, or the equivalent thereof, is then applied to the emitter and receptor or receptor/collector electrodes (as well as any other desired electrodes, e.g. driver electrodes). The current passing from the emitter to the receptor or receptor/collector electrode is then measured and compared to the current passing from the emitter to the receptor or receptor/collector electrode in the same arrangement but with the designed effective resistor only shielding the designed shielded area and without the insulator(s) shielding the designed unshielded area. The amount of current passing to the receptor or receptor/collector electrode from the emitter must be less than 50%, preferably less than 90%, and most preferably less than 95% of the current passing to the same electrode without the insulator(s).
Thus, as used herein, the term “effective resistor” indicates a material which has a sufficient volume resistivity and thickness to block the stated percentages of ionization current. As defined herein, an “insulator” is an “effective resistor,” but an “effective resistor” is not necessarily an “insulator.”

According to other embodiments which are less preferred, a shielded region of a receptor electrode comprises at least one of a change in continuity or a change in curvature of a surface of the receptor electrode, but the shielded region does not comprise the portion of the receptor electrode which is closest to the emitter. Nonetheless, by shielding these shielded regions, the likelihood of ionization current concentrations at the changes in continuity/curvature is greatly reduced.

While only the embodiment of FIG. 3 has been illustrated with a fan, one or more fans can be utilized with all embodiments of the present invention and can be positioned upstream and/or downstream of the ionization section. Additionally, electrostatic propulsion can affect the movement of the gas, though possibly very slightly. As noted above, the electrostatic propulsion moves air from the emitter to the current accepting surfaces. In FIGS. 9, 27, 29 and 34 the current downstream and upstream are similar and there is no resultant electrostatic propulsion. In FIGS. 28 and 30 the resultant electrostatic propulsion is in the upstream direction. In the other figures, the resultant electrostatic propulsion is in the downstream direction.

According to another aspect of the present invention, the safety of the electrostatic precipitator is increased by connecting a resistor between a high voltage power supply and each emitter, and/or between the high voltage power supply and each receptor electrode, or subgroups of a plurality, e.g. two, of said emitters or receptor electrodes, in order to limit the current passed to a person who accidentally touches the emitter or receptor during operation. This safety feature greatly increases the safety to a healthy person who bypasses the housing and other safety features, and contacts an emitter or receptor electrode. For example, use of a 20 Mohm resistor between a high voltage power supply generating a 13 kV ionization voltage and an emitter, will sufficiently reduce the current passed to a healthy (grounded) person so that the person receives a harmless shock when the emitter was touched.

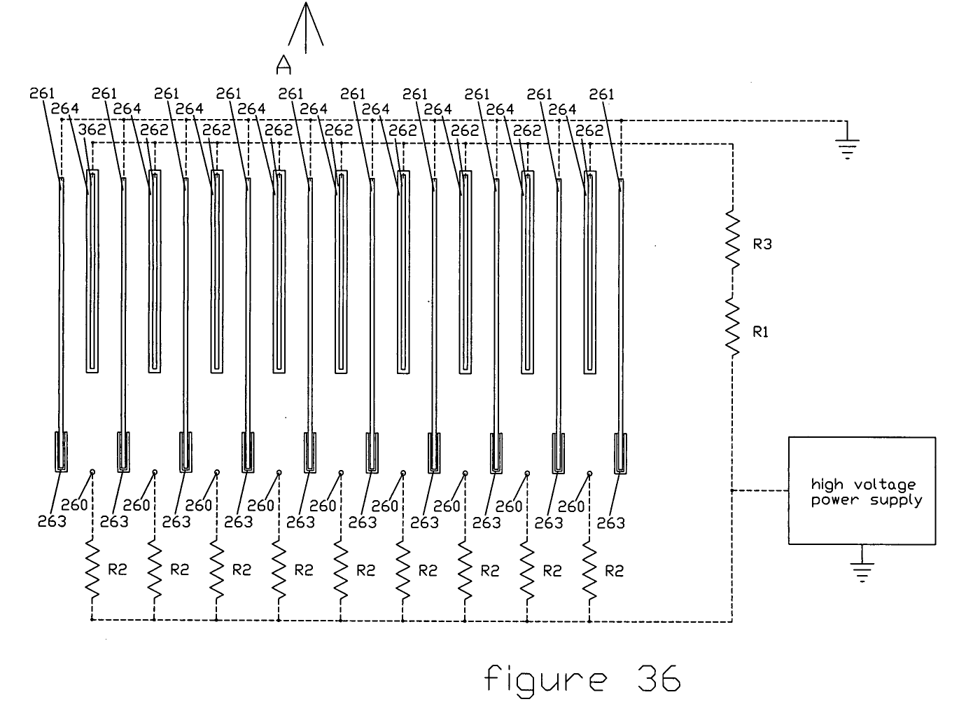

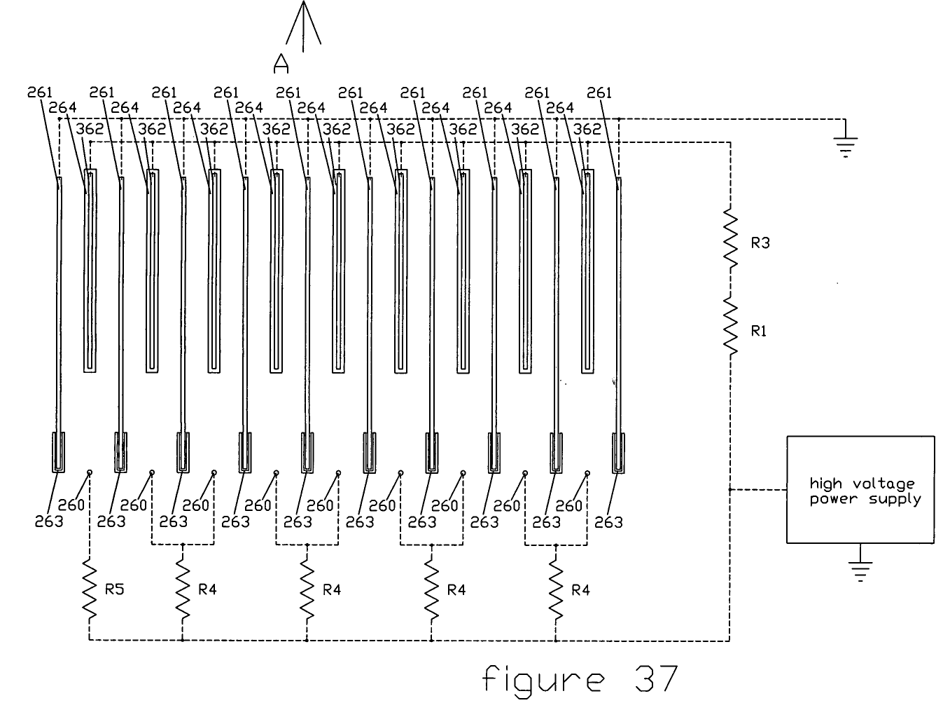

According to one embodiment of the present invention illustrated in FIG. 36, individual resistors R2 are positioned between the high voltage power supply and each emitter 260. Disposing an individual resistor in the electrical path between the high voltage power supply and each resistor as illustrated in FIG. 36 increases the safety of the device to technicians and users since the current passing through each resistor is the individual current through each emitter/receptor sets and not the sum of all of the emitter/receptor pairs. The electrical potential drop across each resistor will be small compared to a circuit where only a single protective resistor is used between a high voltage power supply and all emitters. The design of this aspect of the present invention will also minimize undesirable power losses and allow the use of resistors having higher resistance. Additionally, only the energy stored in the capacitance of one or two adjoining emitter/receptor pairs will likely be released during accidental contact since the likelihood of a person touching more than two emitters/receptor pairs at the same time is generally low due to the spacing between these elements. In practice, resistors are preferably potted along with other high voltage circuitry so that a user cannot access the actual output of the high voltage power supply. With reference again to FIG. 36, resistors are R1 and R2 are preferably potted together with other high voltage circuitry so that it is not possible for a user to touch the output of the high voltage power supply directly even if all safety guards and interlocks fail. Resistor R3 is preferably located on a removable driver and receptor/collector module. Resistor R3 reduces any shock to users which might occur due to the electrical energy stored in capacitance between the driver plates and the receptor/collector plates.

With reference to FIG. 37, it is not necessary that each resistor is connected to only one emitter/receptor set in order to provide the enhanced safety benefits. For less powerful devices, i.e. electrostatic precipitators operating at lower voltages, one resistor can be connected to a plurality of emitter/receptor sets. Safety advantages are obtained by dividing the emitter/receptor pairs into more than two groups and connecting each group to the high voltage power supply circuit through a resistor. FIG. 37 shows a configuration wherein eight emitters 260 are subdivided into four subgroups of two emitters each, and each subgroup is provided with electrical potential through a separate resistor R4. A ninth emitter 260 shown on the left in FIG. 37 is provided with electrical potential through a resistor R5. In the embodiments illustrated in FIGS. 36 and 37, the receptor electrodes are connected to ground.

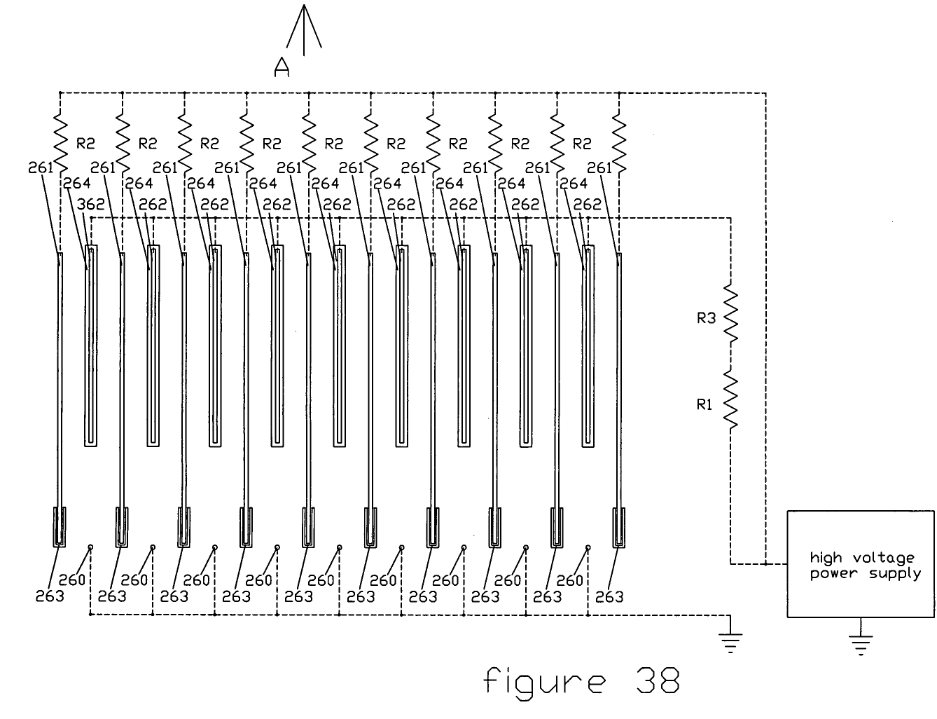

FIG. 38 illustrates an alternative design wherein a resistor R2 is provided between the high voltage power supply and each receptor/collector electrode 261. In this embodiment, the emitters are grounded as illustrated.

The safety enhancement of the embodiments of the present invention illustrated in FIGS. 36-38 provide protection to a person from the capacitance stored in an emitter or receptor electrode relative to a ground potential since a person is normally at ground potential when an accident occurs. The advantages of the present invention are not limited to circuits wherein either the emitters or receptor electrodes are grounded. While FIG. 38 shows resistors R2 connected to each individual receptor/collector electrode 261, resistors can also be connected to subgroups each comprising a plurality of receptor/collector electrodes similar to the way that receptors R4 are connected to subgroups comprising a plurality of emitters 260 as shown in FIG. 37. It is also possible to provide resistors for the emitters, for example, as shown in FIGS. 36 and 37 while also providing resistors for the receptor electrodes, for example as shown in FIG. 38 or as otherwise described herein.

Some of the benefits of the present invention are illustrated by a comparison test described in the following Example.

### EXAMPLE

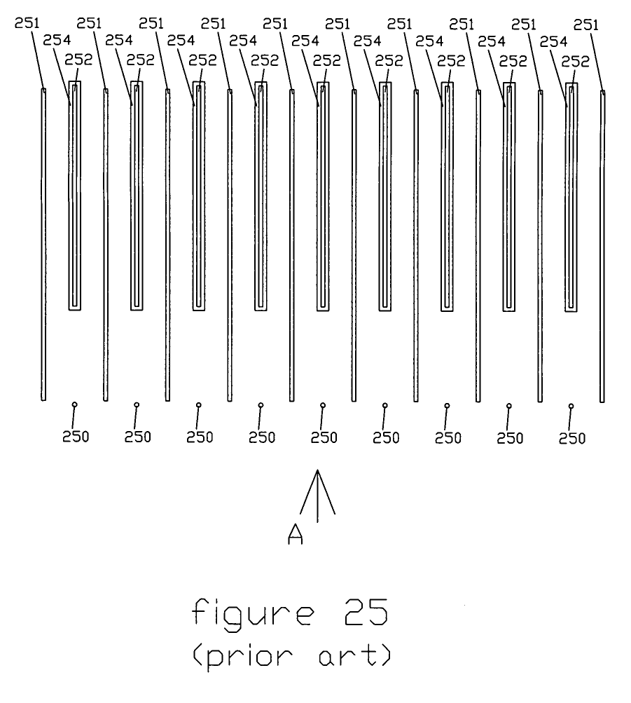

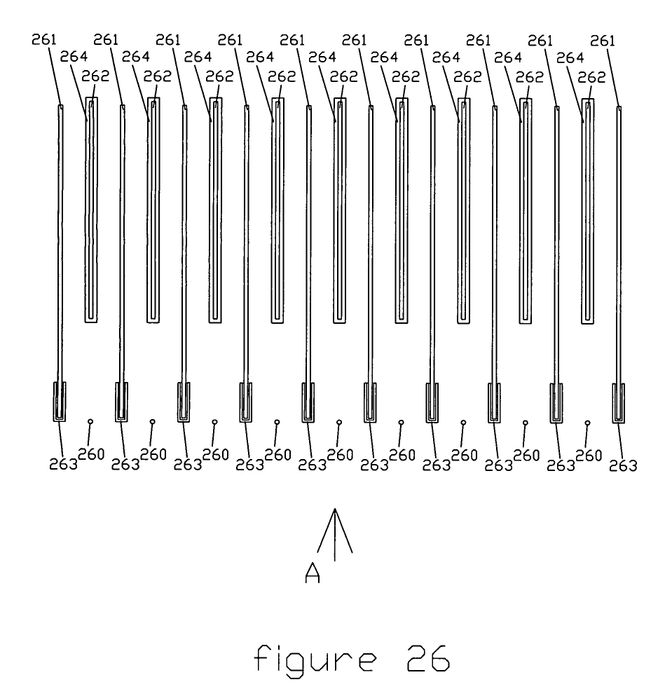

A comparison test was performed using air cleaners arranged in the configurations shown in FIG. 25 and FIG. 26. In the FIG. 25 configuration, the receptor/collector electrode plates 251 were 450 mm long, 100 mm wide and 0.5 mm thick aluminum sheet. These receptor/collector electrodes were spaced 14 mm apart in a parallel manner. The emitter wires 250 were a commercially available 0.12 mm diameter tungsten wire. Ten receptor/collector plates 251, nine emitter wires and nine driver electrodes 252 insulated with insulator 254 were arranged as shown in FIG. 25. A potential difference of about 5 Kv was applied between the emitter wire and the receptor/collector plates to produce a corona current of about 350 microampere without arcing. The CADR (clean air delivery rate) for dust as defined in ANSI/AHAM AC-1-2006 and the ozone concentration according to UL Ozone Standard 867 were measured. This arrangement had a CADR for dust of around 160 and generated 7 parts per billion ozone.

The second air cleaner had the configuration shown in FIG. 26, i.e. the same general arrangement as that of FIG. 25 above except the edges of the receptor/collector plates 261 were shielded with a coating of polyester film 263 having a thickness of around 0.12 mm. The polyester film extended 15 mm from the longitudinal edges and for a major portion of the transverse edges of the receptor/collector plates 263. A potential difference of 13 kV was applied between the emitter wire and the partially shielded receptor/collector plates 263 to produce an ionization current of around 140 microampere without arcing. The CADR for dust as defined in ANSI/AHAM AC-1-2006 and ozone concentration according to UL Ozone Standard 867 were measured and found to be 200 CADR for dust and 3 parts per billion, respectively.

This comparison showed that the configuration of FIG. 26 generates less than 50% of the ozone while providing around 20% increase in CADR for dust when compared to the prior art arrangement of FIG. 25.

1. A device for removing particles from a gas comprising an electrostatic precipitator comprising:
at least one emitter and at least one receptor electrode spaced from said emitter;
said receptor electrode comprising a shielded region comprising at least a first surface, said shielded region comprising at least one of a change of curvature or a change in continuity of said surface;
said receptor electrode also comprising an unshielded region;
means for maintaining said emitter and said receptor electrode at different voltage potentials sufficient to create an ionization current between said emitter and at least a portion of said unshielded region of said receptor electrode; and
at least one effective resistor positioned between said emitter and said shielded region of said receptor electrode to shield said shielded region from said ionization current.

2. A device according to claim 1 wherein said emitter comprises a wire comprising a longitudinal axis, and
said receptor electrode comprises a plate.

3. A device according to claim 2 wherein said effective resistor comprises a longitudinal edge which is generally parallel to said longitudinal axis of said emitter.

4. A device according to claim 2 comprising at least two receptor electrodes comprising shielded regions.

5. A device according to claim 1 wherein said effective resistor is in contact with all of said shielded region.

6. A device according to claim 1 wherein said effective resistor is spaced from at least a portion of said shielded region.

7. A device according to claim 1 wherein said shielded region comprises a first edge and at least a portion of a second edge which is spaced further from said emitter than said first edge.

8. A device according to claim 1 further comprising at least one driver electrode.

9. A device according to claim 8 wherein said driver electrode comprises a plate which is at least partially shielded with an effective resistor.

10. A device according to claim 8 wherein said driver electrode is entirely shielded by an effective resistor.

11. A device according to claim 1 wherein said receptor electrode comprises a unitary collector electrode section.

12. A device according to claim 1 comprising at least one separate collector electrode which is spaced from said receptor electrode.

13. A device according to claim 1 wherein said effective resistor shields all of said change of curvature or change in continuity of said shielded region.

14. A device according to claim 1 wherein said receptor electrode comprises at least one transverse edge and said shielded region comprises at least part of said transverse edge.

15. A device according to claim 1 wherein all edges of said receptor electrode are shielded by an effective resistor.

16. A device according to claim 1 wherein said receptor electrode is formed of a readily conductive material.

17. A device according to claim 1 wherein said emitter is a point-type emitter.

18. A device according to claim 17 wherein said receptor electrode is generally tubular.

19. A device according to claim 1 wherein said emitter comprises a plurality of point-type emitters.

20. A device according to claim 1 wherein at least some of said effective resistor is disposed around at least a portion of an electrode other than said receptor electrode.

21. A device according to claim 20 wherein said other electrode is maintained at a voltage potential which is different from the voltage potential of said receptor electrode.

22. A device according to claim 20 wherein said other electrode is maintained at the same voltage potential as said receptor electrode.

23. A device according to claim 1 wherein said device is a portable air cleaner.

24. A device according to claim 1 wherein a portion of said shielded region is the closest portion of said receptor electrode to said emitter.

25. A device according to claim 1 wherein said effective resistor prevents at least 90% of said ionization current from flowing to said shielded region.

26. A device according to claim 1 wherein said effective resistor prevents at least 95% of said ionization current from flowing to said shielded region.

27. A device according to claim 1 wherein said effective resistor comprises an insulator.

28. A device according to claim 27 wherein said device is a portable air cleaner.

29. A device according to claim 27 wherein said maintaining means causes electrostatic propulsion of said gas.

30. A device according to claim 27 wherein a portion of said shielded region is the closest portion of said receptor electrode to said emitter.

31. A device according to claim 27 wherein said shielded region does not comprise the portion of said receptor electrode which is closest to said emitter.

32. A device according to claim 27 wherein said receptor electrode is a receptor/collector electrode.

33. A device according to claim 1 wherein said device is a portable air cleaner.

34. A device according to claim 1 wherein said maintaining means causes electrostatic propulsion of said gas.

35. A device according to claim 1 wherein a portion of said shielded region is the closest portion of said receptor electrode to said emitter.

36. A device according to claim 1 wherein said shielded region does not comprise the portion of said receptor electrode which is closest to said emitter.

37. A device according to claim 1 wherein said receptor electrode is a receptor/collector electrode.

38. A device for removing particles from a gas comprising an electrostatic precipitator comprising:
at least one emitter and at least one receptor electrode spaced from said emitter;
said receptor electrode comprising a shielded region comprising at least a portion of a first surface, wherein said portion of said first surface does not comprise a change in curvature or a change in continuity;
said receptor electrode also comprising an unshielded region positioned downstream of said shielded region;
means for maintaining said emitter and said receptor electrode at different voltage potentials sufficient to create an ionization current between said emitter and at least a portion of said unshielded region of said receptor electrode; and
at least one effective resistor positioned between said emitter and said shielded region to shield said shielded region from said ionization current.

39. A device according to claim 38 further comprising means for inducing an airflow between said emitter and said receptor electrode, said air flowing from an upstream area toward a downstream area.

40. A device according to claim 38 wherein said maintaining means causes electrostatic propulsion of said gas.

41. A device according to claim 38 said portion of said first surface comprises the portion of said receptor electrode which is closest to said emitter.

42. A device according to claim 38 wherein said shielded region does not comprise the portion of said receptor electrode which is closest to said emitter.

43. A device according to claim 38 wherein said effective resistor prevents at least 90% of said ionization current from flowing to said shielded region.

44. A device according to claim 38 wherein said effective resistor prevents at least 95% of said ionization current from flowing to said shielded region.

45. A device according to claim 38 wherein said effective resistor comprises an insulator.

46. A device according to claim 45 wherein said insulator is in contact with all of said shielded region.

47. A device according to claim 45 wherein said insulator is spaced from at least a portion of said shielded region.

48. A device according to claim 45 wherein said first surface is substantially planar.

49. A device according to claim 45 wherein said receptor electrode is formed of a readily conductive material.

50. A device according to claim 45 wherein said receptor electrode is generally tubular.

51. A device according to claim 45 comprising at least one separate collector electrode which is spaced from said receptor electrode.

52. A device according to claim 45 wherein said device is a portable air cleaner.

53. A device according to claim 38 wherein said receptor electrode is integrally formed with a collector electrode.

54. A device according to claim 38 further comprising at least one driver electrode.

55. A device according to claim 38 wherein at least some of said effective resistor is disposed around at least a portion of an electrode other than said receptor electrode.

56. A device according to claim 55 wherein said other electrode is maintained at a voltage potential which is different from the voltage potential of said receptor electrode.

57. A device according to claim 55 wherein said other electrode is maintained at the same voltage potential as said receptor electrode.

58. A device for removing particles from a gas comprising an electrostatic precipitator comprising:
at least one emitter and at least one receptor/collector electrode spaced from said emitter;
said receptor/collector electrode comprising a shielded region comprising at least a portion of a first surface, wherein said portion of said first surface comprises the portion of said receptor/collector electrode which is closest to said emitter and said portion of said first surface does not comprise a change in curvature or a change in continuity;
said receptor/collector electrode also comprising an unshielded region positioned downstream of said shielded region;
means for maintaining said emitter and said receptor/collector electrode at different voltage potentials sufficient to create an ionization current between said emitter and at least a portion of said unshielded region ; and
at least one effective resistor positioned between said emitter and said shielded region to shield said shielded region from said ionization current.

59. A device for removing particles from a gas comprising an electrostatic precipitator comprising:
at least one emitter and at least one receptor/collector electrode spaced from said emitter;
said receptor/collector electrode comprising a shielded region comprising at least a portion of a first surface, wherein said portion of said first surface comprises the portion of said receptor/collector electrode which is closest to said emitter and said shielded portion comprises a change in curvature or a change in continuity;
said receptor/collector electrode also comprising an unshielded region positioned downstream of said shielded region relative to the flow of the gas;
means for maintaining said emitter and said receptor/collector electrode at different voltage potentials sufficient to create an ionization current between said emitter and at least a portion of said unshielded region of said receptor/collector electrode; and
at least one effective resistor material positioned between said emitter and said shielded region to shield said shielded region from said ionization current.

60. A portable, self-contained air cleaner comprising an electrostatic precipitator comprising:
at least one wire emitter;
at least one plate-type receptor electrode spaced from said emitter, said receptor electrode comprising a shielded region comprising at least a first surface, said shielded region comprising at least one of a change of curvature or a change in continuity of said surface and wherein a portion of said shielded region is the closest portion of said receptor electrode to said emitter;
said receptor electrode also comprising an unshielded region;
means for maintaining said emitter and said receptor electrode at different voltage potentials sufficient to create an ionization current between said emitter and at least a portion of said unshielded region of said receptor electrode; and
insulation positioned between said emitter and said shielded region to shield said shielded region from said ionization current.

61. A portable self-contained air cleaner according to claim 60 wherein said air cleaner comprises at least five receptor electrodes, at least five collector electrodes, a plurality of driver electrodes, at least one fan to induce an airflow past said receptor electrodes, and a protective housing, and
wherein said air cleaner weighs less than 50 pounds.

62. A portable self-contained air cleaner according to claim 60 wherein at least one of said collector electrodes is integrally formed with a receptor electrode.

63. A portable self-contained air cleaner according to claim 60 comprising a plurality of receptor electrodes and wherein at least one of said receptor electrodes is a receptor/collector electrode.

64. A portable self-contained air cleaner according to claim 63 comprising means for inducing a flow of air between said emitter and said receptor electrode from an upstream area to a downstream area, and wherein said shielded portion comprises an upstream edge and at least one surface adjacent to said upstream edge of said receptor electrode.

65. A device for removing particles from a gas comprising an electrostatic precipitator comprising:
a plurality of emitters,
a plurality of receptor electrodes;
a high voltage power supply electrically connected to said plurality of emitters;
a plurality of resistors, wherein different resistors are disposed between said power supply and different emitters.

66. A device for removing particles from a gas comprising an electrostatic precipitator according to claim 65 wherein said subgroups of emitters comprise only one emitter each.

67. A device for removing particles from a gas comprising an electrostatic precipitator according to claim 65 wherein said emitters are electrically connected into a plurality of subgroups each comprising a plurality of emitters.

68. A device for removing particles from a gas comprising an electrostatic precipitator according to claim 65 further comprising different resistors disposed between said power supply and different receptor electrodes.
